(19) United States
(12) Patent Application Publication
(10) Pub. No.: US 2025/0142598 A1
(43) Pub. Date: May 1, 2025

(54) ELECTRONIC APPARATUS AND CONTROLLING METHOD THEREOF

(71) Applicant: Samsung Electronics Co., Ltd., Suwon-si (KR)

(72) Inventors: Donghoon KANG, Suwon-si (KR); Yeonwoo KIM, Suwon-si (KR); Jino SON, Suwon-si (KR); Jeongsoo SHIN, Suwon-si (KR); Kyuyun LEE, Suwon-si (KR); Sohee CHOI, Suwon-si (KR)

(73) Assignee: Samsung Electronics Co., Ltd., Suwon-si (KR)

(21) Appl. No.: 18/893,226

(22) Filed: Sep. 23, 2024

Related U.S. Application Data
(63) Continuation of application No. PCT/KR2024/012009, filed on Aug. 12, 2024.

(30) Foreign Application Priority Data
Nov. 1, 2023 (KR) 10-2023-0149454

(51) Int. Cl. H04W 72/30; H04L 5/00; H04W 8/18

(52) U.S. Cl. CPC H04W 72/30; H04L 5/0048; H04W 8/18

(57) ABSTRACT

An electronic apparatus included in an Internet of Things (IoT) network includes a communication interface, and at least one processor. The at least one processor is configured to, based on occurrence of an event in which control information allowing control over a target apparatus be provided, identify a target apparatus among at least one external apparatus connected with the electronic apparatus, broadcast a packet in association with providing the control information through the communication interface, receive identification information from an apparatus that responds to the packet through the communication interface, and based on the received identification information from the apparatus being included in a pre-stored contact list, provide the control information allowing control over the target apparatus to the apparatus.

### CROSS-REFERENCE TO RELATED APPLICATION(S)

This application is a continuation application, under 35 U.S.C. § 111(a), of international application No. PCT/KR2024/012009, filed on Aug. 12, 2024, which claims priority under 35 U. S. C. § 119 to Korean Patent Application No. 10-2023-0149454 filed on Nov. 1, 2023, the disclosures of which are incorporated herein by reference in their entireties.

### BACKGROUND

### Field

The disclosure relates to an electronic apparatus and a controlling method thereof, and more particularly, to an electronic apparatus that shares a control right for an Internet of Things (IoT) device by using identification information, and a controlling method thereof.

### Description of the Related Art

Various IoT devices such as a TV, an air conditioner, an air purifier, a lighting, an AI speaker, etc. are being used. A user may identify the states of IoT devices with an application of a smartphone, and control the IoT devices.

A TV is generally located in the center of a living room inside a home, and may include a display. A TV may operate in a lower power mode when the power is turned off, and perform a specific function.

In the case of wanting to control an IoT device included in an IoT network, a terminal device of a pre-registered user may be used. The IoT network may control the IoT device by using an access point (AP) device, etc. The terminal device of the pre-registered user may control the IoT device by using the AP device.

A user who was not registered in advance (a visitor) should access an AP or perform a new connecting operation for controlling an IoT device. There may be inconvenience that a pre-registered user should inform a user who was not registered in advance (a visitor) about a method for controlling an IoT device.

In the case of wanting to share (or grant) a control authority (a control right) for a specific IoT device with a visitor, a preliminary preparation process of connecting to an IoT network may exert inconvenience to all users (a pre-registered user, a visitor).

For example, in the case of having a meeting or a party in a specific place, a wireless Wi-Fi environment may be shared with a visitor's terminal device, and a control right for IoT devices connected to the Wi-Fi may be shared with the visitor's terminal device. The visitor's terminal device that was temporarily provided with the control right for the IoT devices can perform control for the IoT devices during a specific period.

When granted a control right, a visitor's terminal device can easily share an image or a video with a TV, and adjust a temperature of an air conditioner. Also, the visitor's terminal device can change a color of a lighting, and reproduce specific music at an AI speaker.

However, for providing a control right for an IoT device to a visitor's terminal device, the name of an AP, a password, a QR code, etc. should be provided to the visitor. Also, the visitor should go through a complex process for connecting to an IoT network directly.

### SUMMARY

The disclosure was devised for improving the aforementioned problem, and the purpose of the disclosure is in providing an electronic apparatus that shares a control right for an IoT device by using contact number of a visitor's terminal device, and a controlling method thereof.

According to an embodiment, an electronic apparatus may include a communication interface and at least one processor configured to based on occurrence of an event in which control information allowing control over a target apparatus be provided, identify the target apparatus among at least one external apparatus connected with the electronic apparatus, broadcast a packet, in association with providing the control information, through the communication interface, receive identification information, from an apparatus that responds to the packet, through the communication interface, and based on the received identification information from the apparatus being included in pre-stored identification information, provide the control information allowing control over the target apparatus to the apparatus.

The event is a user input requesting the control information, and the at least one processor may broadcast the packet by using Bluetooth Low Energy (BLE) communication through the communication interface.

The at least one processor may based on a contact number obtained through the received identification information being included in the pre-stored identification information, transmit information of an access point (AP) through which the electronic apparatus is connected to the apparatus that responded to the packet through the communication interface.

The at least one processor may based on a contact number obtained through the received identification information not being included in the pre-stored identification information, control a user interface (UI) to be provided to check a connection authority of the apparatus that responded to the packet.

The at least one processor may receive account information from the apparatus that responded to the packet through the communication interface, and based on the received account information being included in a pre-stored account list, provide the control information to the apparatus that responded to the packet based on the account information.

The at least one processor may based on the received account information not being included in the pre-stored account list, generate temporary account information, and provide the control information to the apparatus that responded to the packet based on the temporary account information.

The at least one processor may generate the temporary account information based on a contact number obtained through the identification information received from the apparatus that responded to the packet.

The at least one processor may update the account information received from the apparatus such that the control information for the target apparatus is added to the account information.

The at least one processor may based on the event being receiving a user input to provide the control information, control to maintain a state for providing the control information to the apparatus that responded to the packet during a predetermined time, and wherein the control information is no longer provided, based on the predetermined time passing, to the apparatus that responded to the packet.

The at least one processor may obtain signal strength of the at least one external apparatus connected with the electronic apparatus, respectively, and based on the signal strength, of an external apparatus among the at least one external apparatus, being greater than or equal to a threshold value, identify the external apparatus as the target apparatus.

According to an embodiment, a controlling method of an electronic apparatus may include based on occurrence of an event in which control information allowing control over a target apparatus be provided, identifying the target apparatus among at least one external apparatus connected with the electronic apparatus, broadcasting a packet in association with providing the control information, receiving identification information from an apparatus that responds to the packet, and based on the received identification information from the apparatus being included in pre-stored identification information, providing the control information allowing control over the target apparatus to the apparatus.

The event is a user input requesting the control information, and the broadcasting of the packet may include broadcasting the packet by using Bluetooth Low Energy (BLE) communication.

The controlling method may include based on a contact number obtained through the received identification information being included in the pre-stored identification information, transmitting information of an access point (AP) through which the electronic apparatus is connected to the apparatus that responded to the packet.

The controlling method may include based on a contact number obtained through the received identification information not being included in the pre-stored identification information, controlling a user interface (UI) to be provided to check a connection authority of the apparatus that responded to the packet.

The controlling method may include receiving account information from the apparatus that responded to the packet, and based on the received account information being included in a pre-stored account list, providing the control information to the apparatus that responded to the packet based on the account information.

### BRIEF DESCRIPTION OF THE DRAWINGS

FIG. 1 is a block diagram illustrating an electronic apparatus according to an embodiment of the disclosure;

FIG. 2 is a block diagram for illustrating a detailed configuration of the electronic apparatus in FIG. 1 according to an embodiment of the disclosure;

FIG. 3 is a diagram for illustrating an IoT system according to an embodiment of the disclosure;

FIG. 4 is a diagram for illustrating an IoT system according to an embodiment of the disclosure;

FIG. 5 is a diagram for illustrating an IoT system according to an embodiment of the disclosure;

FIG. 6 is a diagram for illustrating an IoT system according to an embodiment of the disclosure;

FIG. 7 is a flow chart for illustrating an operation of starting sharing of IoT control according to an embodiment of the disclosure;

FIG. 8 is a flow chart for illustrating an operation of ending sharing of IT control according to an embodiment of the disclosure;

FIG. 9 is a flow chart for illustrating sharing of IoT control according to various embodiments of the disclosure;

FIG. 10 is a diagram for illustrating a UI for starting of sharing of IoT control according to an embodiment of the disclosure;

FIG. 11 is a diagram for illustrating a notification related to sharing of IoT control according to an embodiment of the disclosure;

FIG. 12 is a diagram for illustrating an operation of detecting a visitor according to an embodiment of the disclosure;

FIG. 13 is a diagram for illustrating an operation of selecting a target IoT device according to an embodiment of the disclosure;

FIG. 14 is a diagram for illustrating an operation of selecting a target IoT device for each group according to an embodiment of the disclosure;

FIG. 15 is a diagram for illustrating an operation of selecting a visitor according to an embodiment of the disclosure;

FIG. 16 is a diagram for illustrating an operation of selecting a sharing mode according to an embodiment of the disclosure;

FIG. 17 is a diagram for illustrating an operation of providing an invitation notification through a text message service according to an embodiment of the disclosure;

FIG. 18 is a diagram for illustrating an operation of providing an invitation notification according to an embodiment of the disclosure;

FIG. 19 is a diagram for illustrating an operation of accepting an invitation notification through an NFC function according to an embodiment of the disclosure;

FIG. 20 is a diagram for illustrating an operation of accepting an invitation notification through a QR code according to an embodiment of the disclosure;

FIG. 21 is a diagram for illustrating an operation of accepting an invitation notification through a watermark according to an embodiment of the disclosure;

FIG. 22 is a diagram for illustrating an operation of checking a contact number according to an embodiment of the disclosure;

FIG. 23 is a diagram for illustrating a screen that is displayed in case checking of a contact number failed according to an embodiment of the disclosure;

FIG. 24 is a diagram for illustrating a screen that is displayed in case checking of a contact number failed according to an embodiment of the disclosure;

FIG. 25 is a diagram for illustrating a screen that is displayed in case checking of a contact number failed according to an embodiment of the disclosure;

FIG. 26 is a diagram for illustrating an operation of adding a target IoT device to visitor account information according to an embodiment of the disclosure;

FIG. 27 is a diagram for illustrating a screen that is displayed in case checking of an account failed according to an embodiment of the disclosure;

FIG. 28 is a diagram for illustrating an operation of sharing an image content according to an embodiment of the disclosure;

FIG. 29 is a diagram for illustrating an operation of sharing an audio content according to an embodiment of the disclosure;

FIG. 30 is a diagram for illustrating an operation of sharing a game content according to an embodiment of the disclosure;

FIG. 31 is a diagram for illustrating an operation of deleting a control right according to an embodiment of the disclosure;

FIG. 32 is a diagram for illustrating a screen related to ending of sharing of IoT control according to an embodiment of the disclosure;

FIG. 33 is a flow chart for illustrating an operation wherein AP information is included in a BLE packet according to an embodiment of the disclosure;

FIG. 34 is a flow chart for illustrating an operation of performing checking of a contact number and checking of an account in an electronic apparatus according to an embodiment of the disclosure;

FIG. 35 is a flow chart for illustrating an operation wherein checking of a contact number is performed at a user terminal device and checking of an account is performed at an electronic apparatus according to an embodiment of the disclosure;

FIG. 36 is a flow chart for illustrating an operation wherein checking of a contact number and checking of an account are performed at a server according to an embodiment of the disclosure;

FIG. 37 is a flow chart for illustrating an operation of performing sharing of IoT control by using only a contact number according to an embodiment of the disclosure;

FIG. 38 is a flow chart for illustrating a controlling method of an electronic apparatus according to an embodiment of the disclosure; and

FIG. 39 is a diagram for illustrating a screen related to sharing of IoT control according to an embodiment of the disclosure.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, as long as they do not obviously mean differently in the context. In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” may perform at least one function or operation, and may be implemented as hardware or software, or as a combination of hardware and software. Also, a plurality of “modules” or a plurality of “parts” may be integrated into at least one module and implemented as at least one processor (not shown), except “a module” or “a part” that needs to be implemented as specific hardware.

In addition, in this specification, the term “a user” may refer to a person who uses an electronic apparatus or an apparatus using an electronic apparatus (e.g.: an artificial intelligence electronic apparatus).

The disclosure was devised for improving the aforementioned problem, and the purpose of the disclosure is in providing an electronic apparatus that shares a control right for an IoT device by using contact number of a visitor's terminal device, and a controlling method thereof.

An electronic apparatus included in an Internet of Things (IoT) network includes a communication interface, and at least one processor, wherein the at least one processor is configured to, based on receiving a user input for sharing a control right for an IoT network, determine a target IoT device of which control right will be shared among at least one IoT device included in the IoT network, broadcast a communication packet for sharing the control right through the communication interface, receive contact number from a terminal device in response to the communication packet through the communication interface, and based on the received contact number being included in a pre-stored contact list, share the control right with the terminal device corresponding to the contact number.

Hereinafter, an embodiment of the disclosure will be described in more detail with reference to the accompanying drawings.

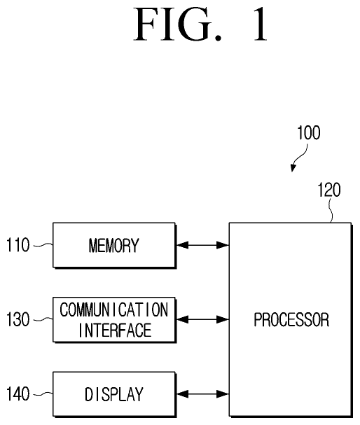

FIG. 1 is a block diagram illustrating an electronic apparatus 100 according to an embodiment of the disclosure.

Referring to FIG. 1, the electronic apparatus 100 may include at least one of a memory 110, at least one processor 120, a communication interface 130, or a display 140.

The memory 110 may store various kinds of information used in the electronic apparatus 100. The memory 110 may store information related to an IoT network 1000. The memory 110 may store information on IoT devices included in the IoT network 1000. The memory 110 may store information on an access point (AP) corresponding to the IoT network 1000. The memory 110 may store information received from a visitor terminal device 200, a server 300, a user terminal device 400, an AP device 500, etc.

The communication interface 130 may be connected with the visitor terminal device 200, the server 300, the user terminal device 400, the AP device 500, etc. The communication interface 130 may include at least one communication module depending on communication methods.

The display 140 may display various user interfaces (UIs) or screens, etc.

The Internet of Things (IoT) network 1000 may include at least one IoT device. The electronic apparatus 100 may be included in the at least one IoT device.

If a user input for providing control information of an external apparatus connected with the electronic apparatus 100 is received, the at least one processor 120 may identify an apparatus to be controlled among at least one external apparatus connected with the electronic apparatus 100, broadcast a packet corresponding to provision of the control information through the communication interface 130, receive identification information from an apparatus that responded to the packet through the communication interface 130, and if the received identification information is included in pre-stored identification information, provide the control information to the apparatus corresponding to the identification information.

An external apparatus connected to the electronic apparatus 100 may indicate an apparatus included in the IoT network 1000. In the IoT network 1000, at least one apparatus such as the electronic apparatus 100, an external apparatus, etc. may be included.

Control information of an external apparatus connected with the electronic apparatus 100 may include information for controlling an apparatus included in the IoT network 1000. The control information may include at least one of a subject to be controlled, a control command, a control signal, a control code, a control type, or a control authority for controlling a specific apparatus.

A user input for providing control information may be described as a user input for sharing a control right.

An apparatus to be controlled may be described as a target IoT device.

A packet corresponding to provision of control information may be described as a communication packet for sharing a control right.

An apparatus that responded to a packet may be described as a terminal device.

Identification information may indicate information used in distinguishing a specific subject (e.g., a user, an apparatus, etc.). The identification information may include contact information.

An operation of providing control information may include an operation of providing a control authority.

If a user input for sharing a control right for the IoT network 1000 is received, the at least one processor 120 may determine a target IoT device of which control right will be shared among the at least one IoT device included in the IoT network 1000, broadcast a communication packet for sharing the control right through the communication interface 130, receive contact information from the terminal device 200 in response to the communication packet through the communication interface 130, and if the received contact information is included in a pre-stored contact list, share the control right with the terminal device 200 corresponding to the contact information.

The at least one processor 120 may receive (or obtain) a user input for sharing the control right for the IoT devices included in the IoT network 1000.

An operation of sharing the control right may mean an operation of temporarily granting the control right to a user who was not registered in advance (a visitor). If a predetermined event is identified, the at least one processor 120 may control the electronic apparatus 100 and the IoT network 1000 in a mode of sharing the control right. The mode of sharing the control right may be described as an IoT sharing mode (IoT control sharing), a party mode, a meeting mode, a control right sharing mode, a smart sharing mode, etc.

A user input may be an input for starting sharing of IoT control. According to various embodiments, even if a user input is not received, if a predetermined event is identified, the at least one processor 120 may start sharing of IoT control.

If the electronic apparatus 100 operates in an IoT control sharing mode, the at least one processor 120 may determine a target IoT device. The target IoT device may mean a device of which control right will be shared. Also, the target IoT device may mean a device of which control right will be shared among the at least one IoT device included in the IoT network 1000.

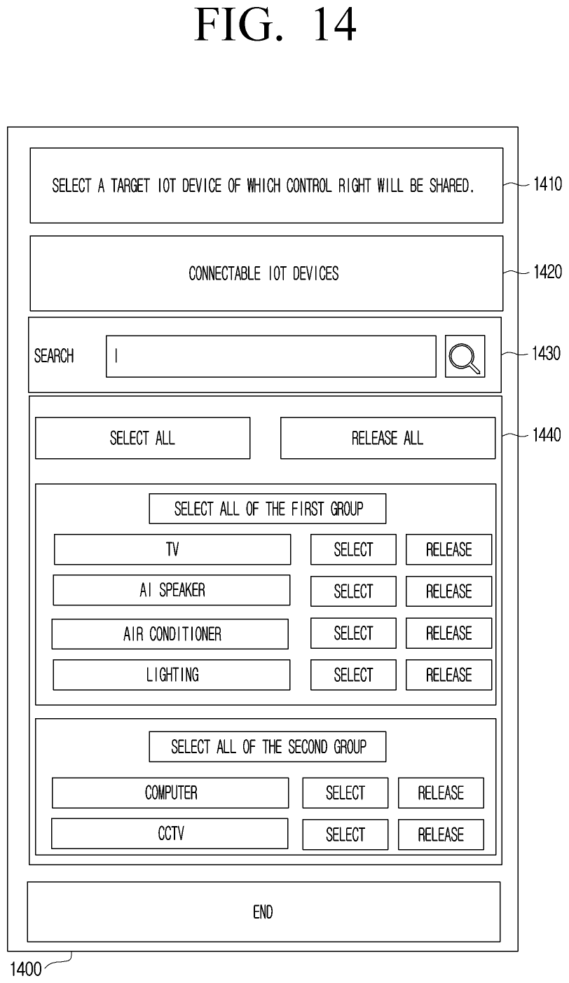

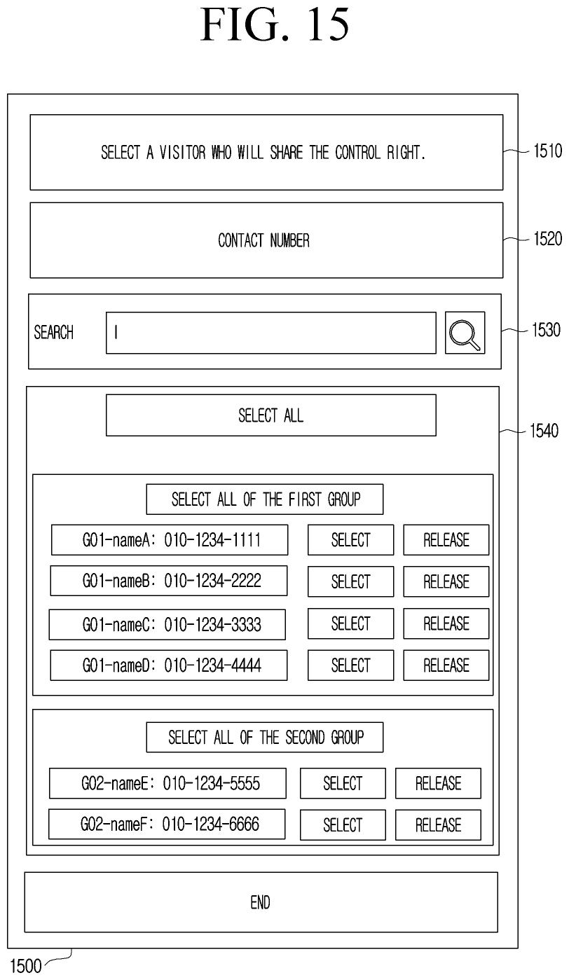

An operation of determining a target IoT device will be described in FIG. 14 and FIG. 15.

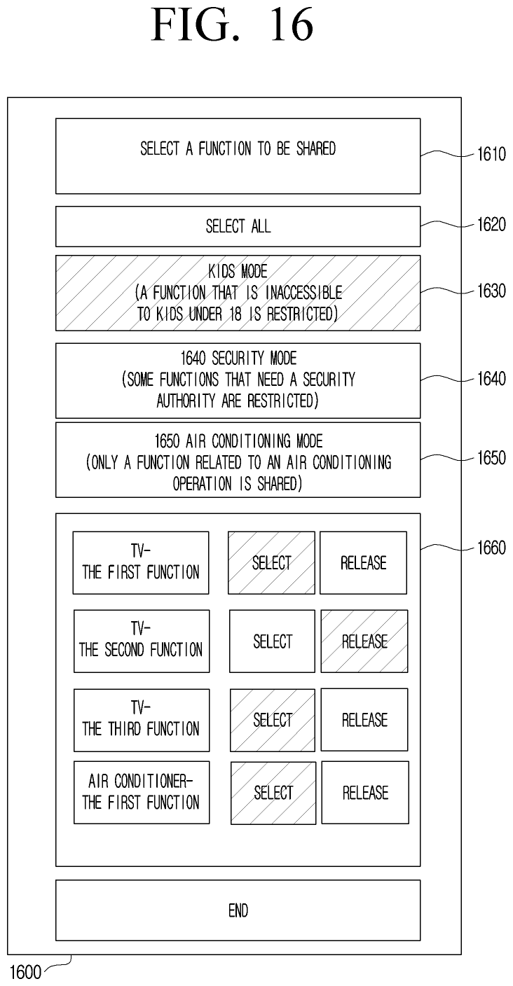

A control right may be shared for each function. For example, a control right for some functions among a plurality of functions provided in one IoT device may be shared. Explanation in this regard will be described in FIG. 16.

The at least one processor 120 may generate a communication packet for sharing of a control right. The communication packet may include a notification message for sharing a control right for an IoT device. The communication packet may be described as an invitation notification. The communication packet may be a Bluetooth Low Energy (BLE) packet. The communication packet may also be described as a request packet.

The at least one processor 120 may broadcast a packet (or a communication packet) by using Bluetooth Low Energy (BLE) communication through the communication interface 130.

The communication packet may include a control command requesting to transmit identification information of a device that receives the communication packet. A device that receives the communication packet may generate a response packet including its identification information.

The visitor terminal device 200 may receive the broadcasted communication packet. The visitor terminal device 200 may include a communication interface. The visitor terminal device 200 may analyze the received communication packet, and recognize that the electronic apparatus 100 intends to share the control right. The visitor terminal device 200 may generate a response packet including identification information in response to the communication packet.

The identification information may include various kinds of information for distinguishing the visitor terminal device 200 from other devices.

For example, the identification information may include at least one of the contact information of the device, the account information of the device, or the model number of the device. The contact information may be described as a contact number or contact data, and the account information may be described as an account or account data. The model number may be described as the unique number of the terminal device or the unique serial number of the terminal device, etc.

When the response packet is received from the visitor terminal device 200, the at least one processor 120 may obtain contact information included in the response packet. The at least one processor 120 may determine whether the visitor terminal device 200 has an authority (or a qualification) to share the control right based on the contact information.

Based on a comparison result of a pre-stored contact list and the contact information of the visitor terminal device 200, the at least one processor 120 may determine whether the visitor terminal device 200 has an authority (or a qualification) to share the control right.

According to an embodiment, an operation of checking a contact number may be performed at the electronic apparatus 100. The electronic apparatus 100 may store a contact list in the memory 110. The electronic apparatus 100 may receive the contact list from the server 300 or the user terminal device 400. The server 300 or the user terminal device 400 may transmit the contact list to the electronic apparatus 100 in response to a request of the electronic apparatus 100.

According to an embodiment, the operation of checking a contact number may be performed at the user terminal device 400. The at least one processor 120 may transmit the contact information to the user terminal device 400. The user terminal device 400 may compare the received contact information with a pre-stored contact list stored in the user terminal device 400. The user terminal device 400 may transmit the result of comparison to the electronic apparatus 100.

According to an embodiment, the operation of checking a contact number may be performed at the server 300. The server 300 may be a server connected with the IoT network 1000. The server 300 may also be a server that manages an account related to a service of controlling an IoT device.

For example, the electronic apparatus 100 may transmit contact information to the server 300. The server 300 may compare the received contact information and a contact list corresponding to the electronic apparatus 100. The server 300 may transmit the result of comparison to the electronic apparatus 100.

For example, the electronic apparatus 100 may transmit contact information and account information to the server 300. The server 300 may identify a contact list corresponding to the received account information. The server 300 may compare the received contact list and the received contact information. The server 300 may transmit the result of comparison to the electronic apparatus 100.

The electronic apparatus 100 may determine whether the visitor terminal device 200 has an authority (or a qualification) to be connected to the IoT network 1000 based on the result of comparison.

If it is identified that the contact information of the visitor terminal device 200 is included in the contact list based on the result of comparison, the at least one processor 120 may determine that the visitor terminal device 200 has an authority (or a qualification) to be connected to the IoT network 1000.

If the contact information obtained through the received identification information is included in the contact information included in the pre-stored identification information, the at least one processor 120 may transmit information on an access point (AP) to which the electronic apparatus 100 is connected to the device that responded to the packet through the communication interface 130.

If the received contact information is included in the pre-stored contact list, the at least one processor 120 may obtain information on an access point (AP) corresponding to the IoT network 1000, and transmit the AP information to the terminal device 200 through the communication interface 130.

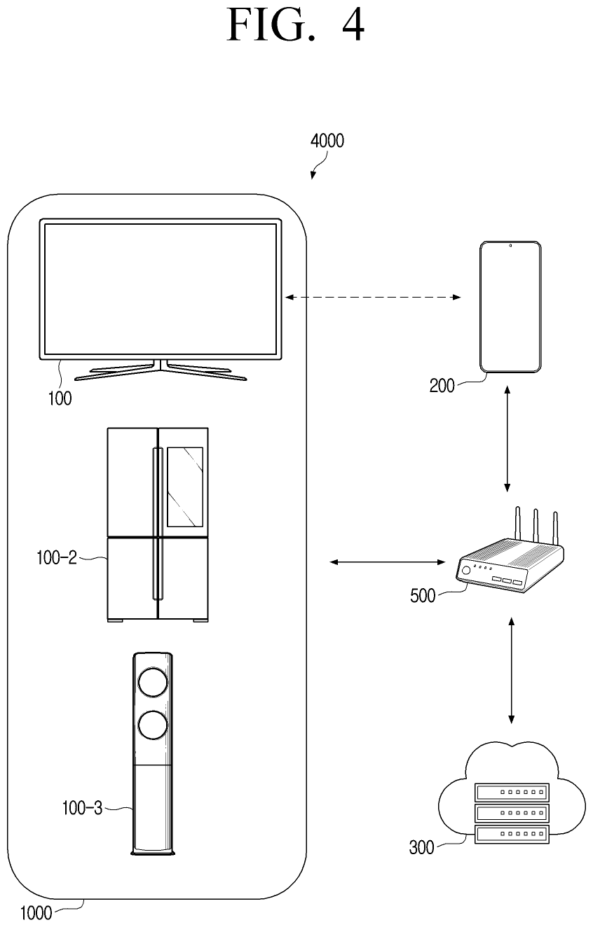

If the received contact information is included in the pre-stored contact list, the at least one processor 120 may transmit the AP information to the visitor terminal device 200 such that the visitor terminal device 200 is connected to the AP corresponding to the IoT network 1000. The AP may mean a device that is used for controlling IoT devices of the IoT network 1000. The AP may mean a router, etc. The AP may be described as an AP device 500. Explanation in this regard will be described in FIG. 4.

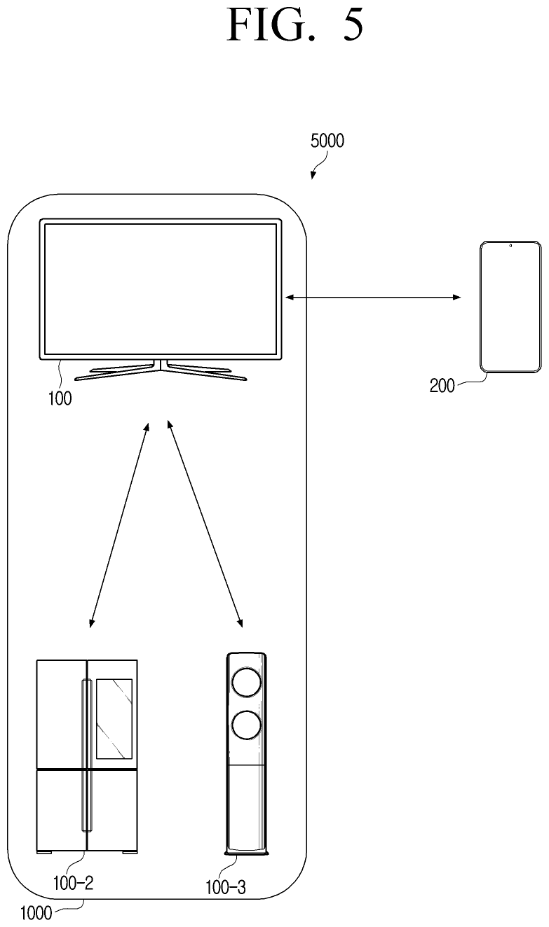

According to various embodiments, the AP may be implemented as an IoT device but not a separate device such as the AP device 500. For example, the electronic apparatus 100 may perform an AP function. Explanation in this regard will be described in FIG. 5.

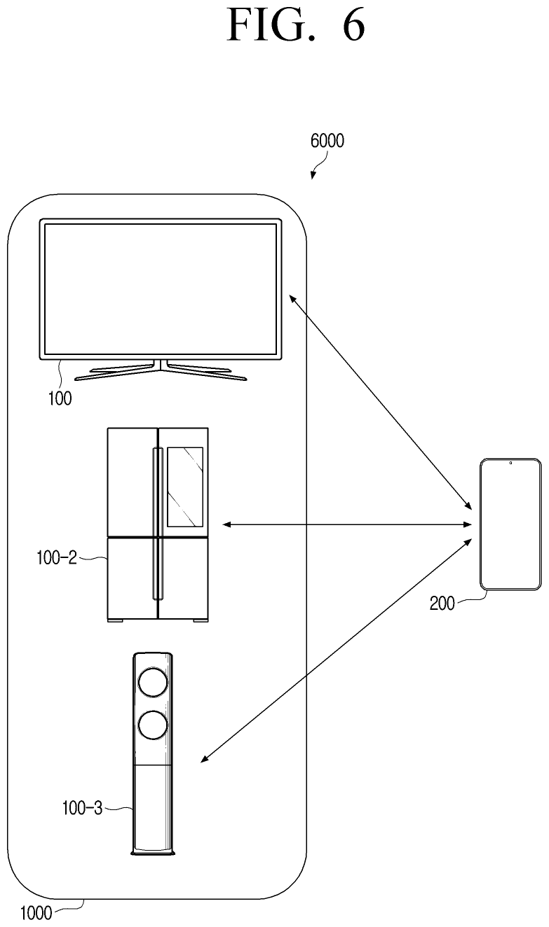

According to various embodiments, communication between IoT devices may be performed without the AP. Explanation in this regard will be described in FIG. 6. Meanwhile, in the aforementioned explanation, it was described that the AP information is obtained, but a control right may be shared without the AP information.

If the contact information obtained through the received identification information is not included in the contact information included in the pre-stored identification information, the at least one processor 140 may perform control to provide a user interface (UI) corresponding to checking of a connection authority of the device that responded to the packet.

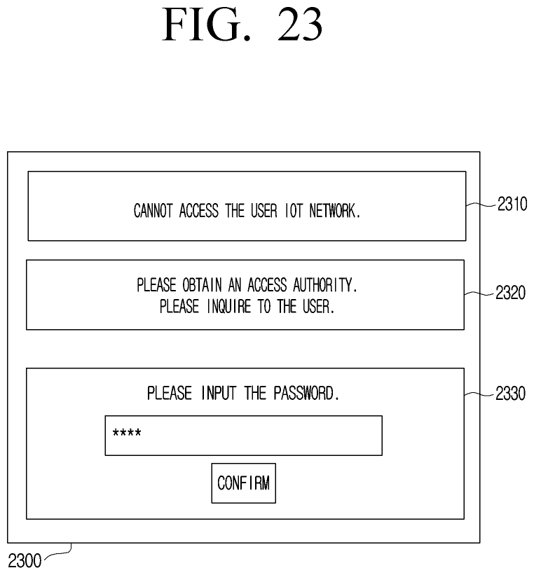

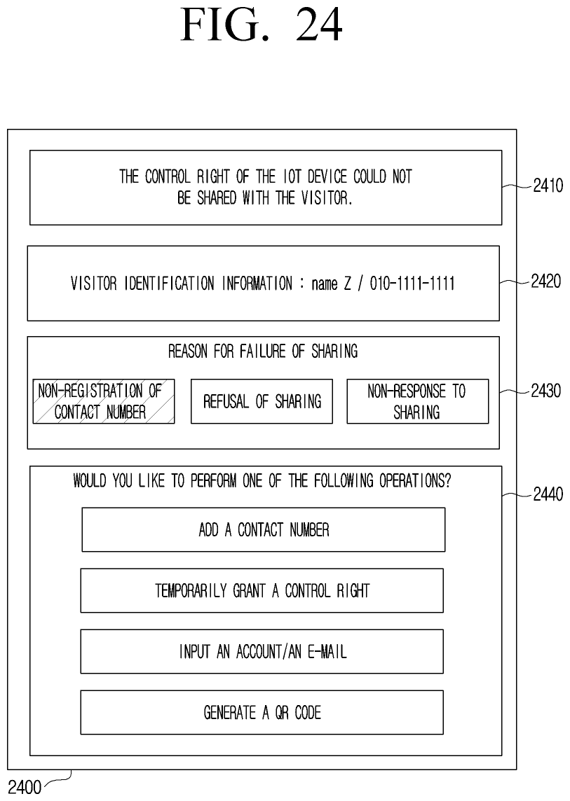

If the received contact information is not included in the pre-stored contact list, the at least one processor 120 may provide a guide user interface (UI) for checking the connection authority of the terminal device 200. Explanation in this regard will be described in FIG. 23 and FIG. 24.

For example, the electronic apparatus 100 may include a display 140. The electronic apparatus 100 may display a guide UI on the display 140.

For example, the electronic apparatus 100 may generate a guide screen including a guide UI. The electronic apparatus 100 may transmit the guide screen to an external apparatus (the visitor terminal device 200 or the user terminal device 400, etc.). The external apparatus may output (or display) the received guide screen.

The at least one processor 120 may receive account information from the device that responded to the packet through the communication interface 130, and if the received account information is included in a pre-stored account list, the at least one processor 120 may provide control information to the device that responded to the packet based on the account information.

The at least one processor 120 may receive account information from the terminal device 200 in response to the communication packet through the communication interface 130, and if the received account information is included in the pre-stored account list, the at least one processor 120 may share the control right with the terminal device 200 corresponding to the contact information.

An operation of checking an account may be additionally performed other than an operation of checking a contact number. It is necessary to specify a user for controlling an IoT device included in the IoT network 1000. This is because there are cases wherein a user owns a plurality of terminal devices. In controlling the IoT network 1000, an account for specifying a user may exist. The account may be an account that is managed at the server 300, etc. related to various services used in controlling IoT devices.

When a response packet is received from the visitor terminal device 200, the at least one processor 120 may obtain account information included in the response packet. The at least one processor 120 may identify whether the visitor terminal device 200 has an authority (or a qualification) to share the control right based on the account information.

Based on a result of comparing the pre-stored account list and the account information of the visitor terminal device 200, the at least one processor 120 may determine whether the visitor terminal device 200 has the authority (or the qualification) to share the control right.

According to an embodiment, the operation of checking an account may be performed at the electronic apparatus 100. The electronic apparatus 100 may store an account list in the memory 110. The electronic apparatus 100 may receive the account list from the server 300 or the user terminal device 400. The server 300 or the user terminal device 400 may transmit the account list to the electronic apparatus 100 in response to a request of the electronic apparatus 100.

According to an embodiment, the operation of checking an account may be performed at the user terminal device 400. The at least one processor 120 may transmit account information to the user terminal device 400. The user terminal device 400 may compare the received account information with a pre-stored account list in the user terminal device 400. The user terminal device 400 may transmit the comparison result to the electronic apparatus 100.

According to an embodiment, the operation of checking an account may be performed at the server 300. The server 300 may be a server connected with the IoT network 1000. The server 300 may also be a server that manages an account related to a service of controlling an IoT device.

As an example, the electronic apparatus 100 may transmit account information to the server 300. The server 300 may compare the received account information and an account list corresponding to the electronic apparatus 100. The server 300 may transmit the comparison result to the electronic apparatus 100.

As an example, the electronic apparatus 100 may transmit account information to the server 300. The server 300 may identify an account list corresponding to the received account information. The server 300 may compare the identified account list and the received account information. The server 300 may transmit the comparison result to the electronic apparatus 100.

The electronic apparatus 100 may determine whether the visitor terminal device 200 has the authority (or the qualification) to be connected to the IoT network 1000 based on the comparison result.

If it is identified that the account information of the visitor terminal device 200 is included in the account list based on the comparison result, the at least one processor 120 may determine that the visitor terminal device 200 has the authority (or the qualification) to be connected to the IoT network 1000.

According to various embodiments, the at least one processor 120 may determine that the visitor terminal device 200 has the authority (or the qualification) to be connected to the IoT network 1000 based on a result of checking the contact number.

According to various embodiments, the at least one processor 120 may determine that the visitor terminal device 200 has the authority (or the qualification) to be connected to the IoT network 1000 based on a result of checking an account.

According to various embodiments, the at least one processor 120 may determine that the visitor terminal device 200 has the authority (or the qualification) to be connected to the IoT network 1000 based on a result of checking the contact number and a result of checking an account.

If the received account information is not included in the pre-stored account list, the at least one processor 120 may generate temporary account information, and provide control information to the device that responded to the packet based on the temporary account information.

If the received account information is not included in the pre-stored account list, the at least one processor 120 may generate temporary account information, and share the control right with the terminal device 200 based on the temporary account information.

The at least one processor 120 may generate temporary account information based on contact information obtained through identification information received from the device that responded to the packet.

The at least one processor 120 may generate temporary account information based on contact information received from the terminal device 200.

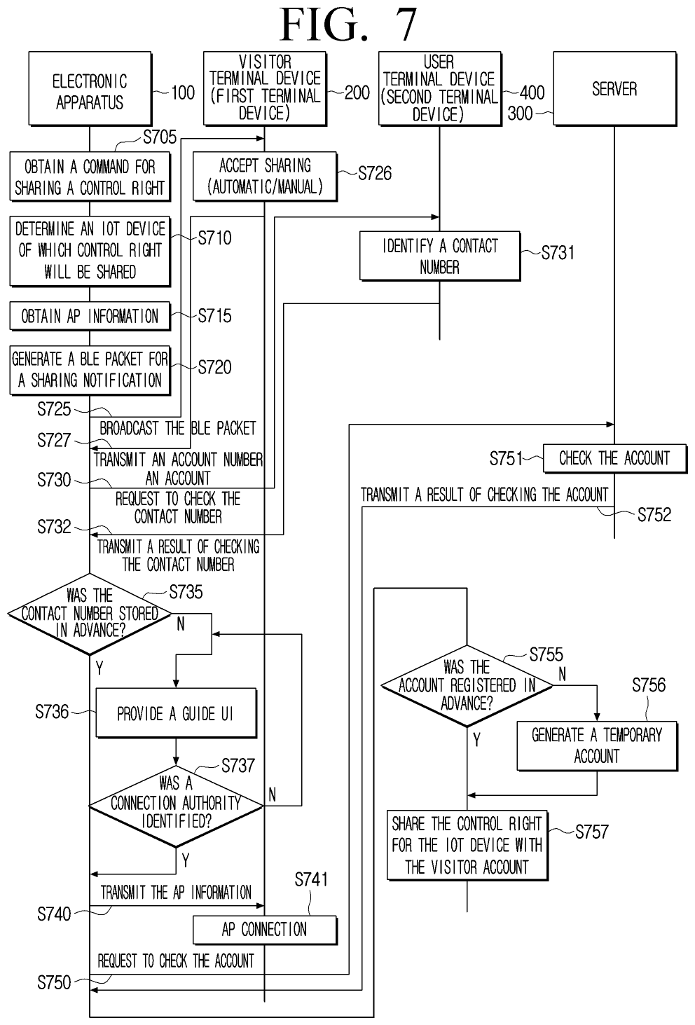

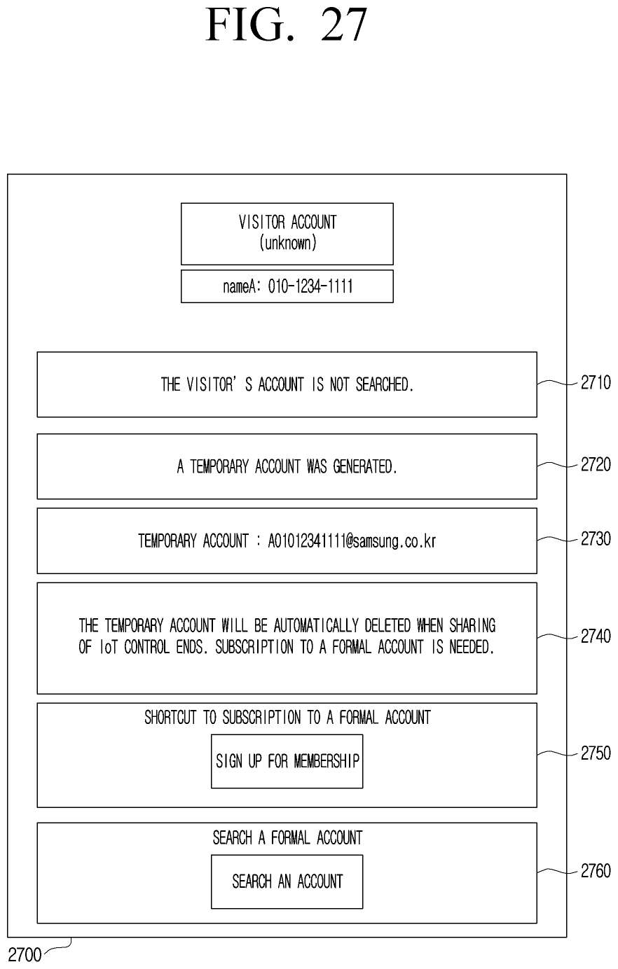

An operation of generating a temporary account will be described in FIG. 7 and FIG. 27.

The at least one processor 120 may update the account information such that control information for a device to be controlled is added to the account information.

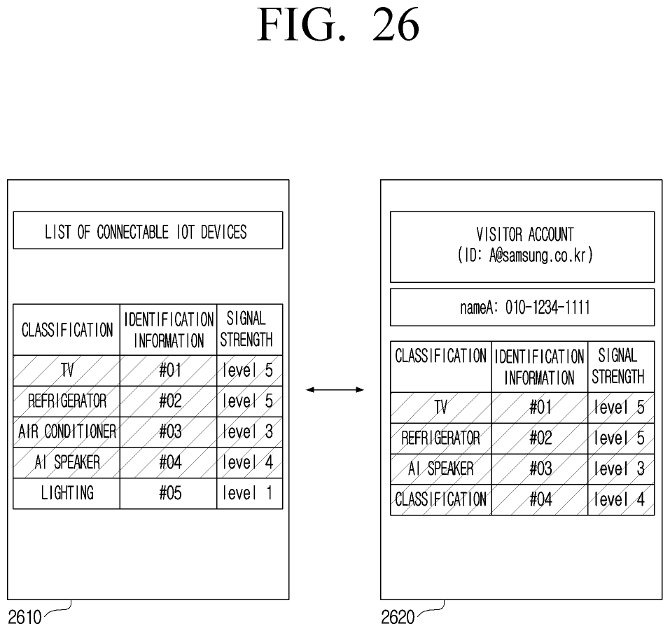

The at least one processor 120 may update the account information such that a control right for a target IoT device is added to the account information. An operation of updating the account information will be described in FIG. 26.

If a user input for providing control information of an external apparatus connected with the electronic apparatus 100 is received, the at least one processor 120 may perform control to maintain a state for providing the control information to the apparatus that responded to the packet during a predetermined time, and if the predetermined time passes, perform control to not provide the control information to the apparatus that responded to the packet.

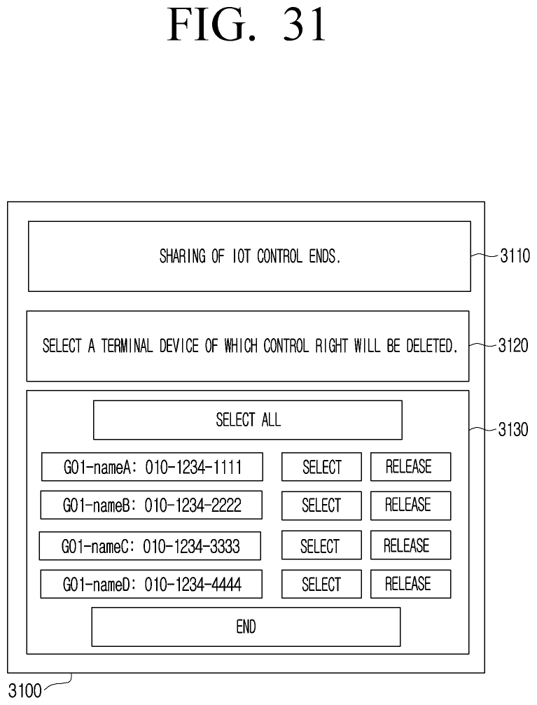

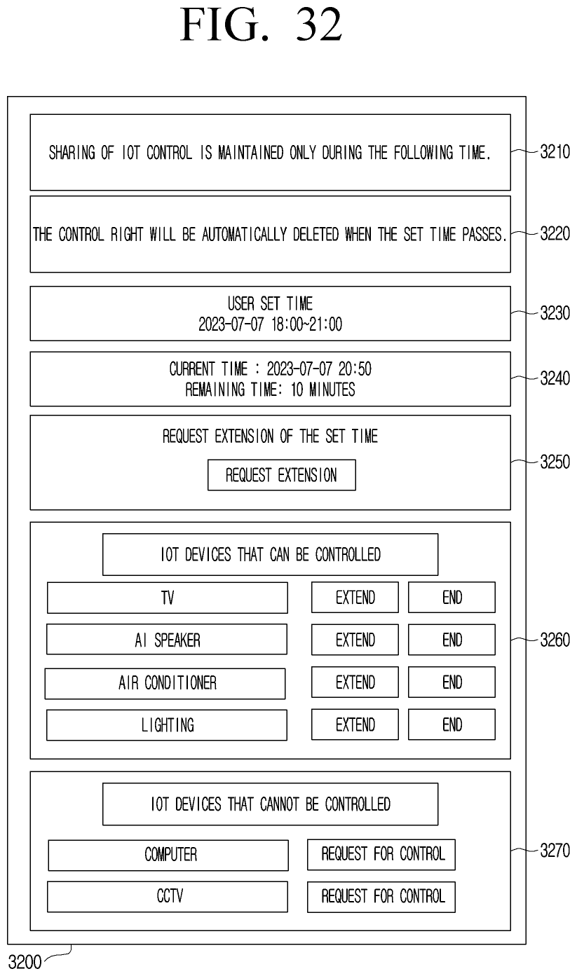

If a user input for sharing a control right for the IoT network 1000 is received, the at least one processor 120 may maintain sharing of IoT control for sharing the control right with the terminal device 200 during the predetermined time, and if the predetermined passes, delete the control right shared with the terminal device 200. Operations in this regard will be described in FIG. 31 and FIG. 32.

The at least one processor 120 may obtain signal strength corresponding to each of the at least one external apparatus connected with the electronic apparatus 100, and identify an external apparatus wherein the signal strength is greater than or equal to a threshold value among the at least one external apparatus as the apparatus to be controlled.

The at least one processor 120 may obtain signal strength corresponding to each of the at least one IoT device included in the IoT network 1000, and determine an IoT device wherein the signal strength is greater than or equal to the threshold value among the at least one IoT device as the target IoT device. An operation in this regard will be described in FIG. 26.

The electronic apparatus 100 may automatically grant an authority to directly control an IoT device to a visitor through a contact number, an account, etc. The visitor may automatically control the IoT device easily without performing a separate connecting operation. The user may share the control right with the visitor without telling information on the IoT device (the network name, the password, etc.) to the user.

The electronic apparatus 100 may allow wireless W-Fi connection of the user to visitors gathered in a specific place, and provide a control right for IoT devices connected to the Wi-Fi during a specific time.

In case there are several visitors, the electronic apparatus 100 may not grant a control right to each of them, but provide a function in a form wherein temporary visitors are automatically invited and accept the invitation.

The electronic apparatus 100 may not give an authority to all visitors, but share the control right only with the visitors who exist in the contact list on the user's mobile.

For example, a case wherein the user threw a party, and a lot of friends visited the party is assumed. The electronic apparatus 100 may obtain contact lists of ambient apparatuses by searching the visitor terminal device 200. The electronic apparatus 100 may identify whether a person is a friend by determining whether his/her contact number belongs to a pre-stored contact list.

The visitor terminal device 200 corresponding to the pre-stored contact list may automatically access the IoT network 1000. The electronic apparatus 100 may send a notification to the visitor terminal device 200 such that the visitor terminal device 200 can get a control right of the IoT devices.

If a response accepting the invitation is received from the visitor terminal device 200 that received the notification, the electronic apparatus 100 may grant an authority such that the visitor terminal device 200 can automatically access the IoT network 1000. The electronic apparatus 100 may transmit a message for installing an application for controlling the IoT devices to the visitor terminal device 200. The visitor terminal device 200 may access an application installation link through the message. The visitor terminal device 200 may control the IoT devices after installing the application.

The electronic apparatus 100 may transmit an invitation notification in advance to a specific user. The electronic apparatus 100 may transmit an invitation notification in advance to some users among a plurality of users included in its contact list. The visitor terminal device 200 that received the invitation notification in advance may immediately connect to (or access) the IoT network 1000.

The visitor terminal device 200 may perform sharing functions such as operation of an air conditioner, adjustment of a lighting, sharing of videos/photos through a TV, reproduction of music, etc. The IoT network 1000 may also transmit notifications generated from IoT devices such as an air purifier and completion of cooking, etc. to the visitor terminal device 200.

The visitor terminal device 200 may share photos/moving images in sharing of IoT control. The electronic apparatus 100 may output an avatar of the visitor terminal device 200. If there are a plurality of visitor terminal devices 200, a plurality of avatars may be displayed.

The electronic apparatus 100 may display a QR code that enables immediate participation in sharing of IoT control.

An IoT device may provide a sharing function of music contents. A music content selected through the visitor terminal device 200 may be output at an IoT device.

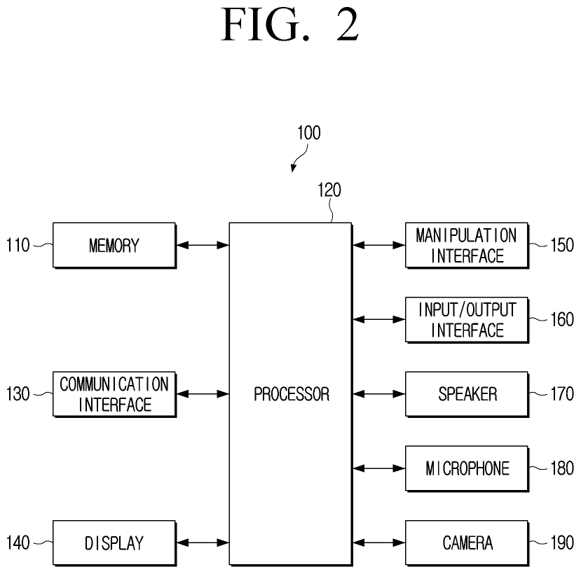

FIG. 2 is a block diagram for illustrating a detailed configuration of the electronic apparatus 100 in FIG. 1.

Referring to FIG. 2, the electronic apparatus 100 may include at least one of a memory 110, at least one processor 120, a communication interface 130, a display 140, a manipulation interface 150, an input/output interface 160, a speaker 170, a microphone 180, or a camera 190.

The memory 110 may be implemented as an internal memory such as a ROM (e.g., an electrically erasable programmable read-only memory (EEPROM)), a RAM, etc., included in the at least one processor 120, or implemented as a separate memory from the at least one processor 120. Also, the memory 110 may be implemented in a form of a memory embedded in the electronic apparatus 100, or implemented in the form of a memory that can be attached to or detached from the electronic apparatus 100 according to the usage of stored data. For example, in the case of data for operating the electronic apparatus 100, the data may be stored in a memory embedded in the electronic apparatus 100, and in the case of data for an extended function of the electronic apparatus 100, the data may be stored in a memory that can be attached to or detached from the electronic apparatus 100.

Meanwhile, in the case of a memory embedded in the electronic apparatus 100, the memory may be implemented as at least one of a volatile memory (e.g.: a dynamic RAM (DRAM), a static RAM (SRAM), or a synchronous dynamic RAM (SDRAM), etc.) or a non-volatile memory (e.g.: an one time programmable ROM (OTPROM), a programmable ROM (PROM), an erasable and programmable ROM (EPROM), an electrically erasable and programmable ROM (EEPROM), a mask ROM, a flash ROM, a flash memory (e.g.: NAND flash or NOR flash, etc.), a hard drive, or a solid state drive (SSD)). Also, in the case of a memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), an external memory that can be connected to a USB port (e.g., a USB memory), etc.

The memory 110 may store at least one instruction. The at least one processor 120 may perform various operations based on the instructions stored in the memory 110.

The at least one processor 120 may be implemented as a digital signal processor (DSP) processing digital signals, a microprocessor, and a time controller (TCON). However, the disclosure is not limited thereto, and the at least one processor 120 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the at least one processor 120 may be implemented as a system on chip (SoC) having a processing algorithm stored therein or large scale integration (LSI), or in the form of a field programmable gate array (FPGA). The at least one processor 120 may perform various functions by executing computer executable instructions stored in the memory.

The communication interface 130 is a component that performs communication with various types of external apparatuses according to various types of communication methods. The communication interface 130 may include a wireless communication module or a wired communication module. Each communication module may be implemented in a form of at least one hardware chip.

A wireless communication module may be a module that communicates with an external apparatus wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. may be transmitted and received first, and connection of communication may be performed by using the information, and various types of information may be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G), etc., other than the aforementioned communication methods.

A wired communication module may be a module that communicates with an external apparatus via wire. For example, a wired communication module may include at least one of a local area network (LAN) module, an Ethernet module, a pair cable, a coaxial cable, an optical fiber cable, or an ultra wide-band (UWB) module.

According to various embodiments, the communication interface 130 may use the same communication module (e.g., a Wi-Fi module) for communicating with an external apparatus such as a remote control apparatus and an external server.

According to various embodiments, the communication interface 130 may use different communication modules for communicating with an external apparatus such as a remote control apparatus and an external server. For example, the communication interface 130 may use at least one of an Ethernet module or a Wi-Fi module for communicating with an external server, and use a Bluetooth module for communicating with an external apparatus such as a remote control apparatus. However, this is merely an example, and the communication interface 130 may use at least one communication module among various communication modules in the case of communicating with a plurality of external apparatuses or external servers.

The display 140 may be implemented as displays in various forms such as a liquid crystal display (LCD), an organic light emitting diodes (OLED) display, a plasma display panel (PDP), etc. Inside the display 140, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. The display 140 may be implemented as a touch screen combined with a touch sensor, a flexible display, a three-dimensional (3D) display, etc. The display 140 according to an embodiment of the disclosure may include not only a display panel outputting images, but also a bezel housing the display panel. In particular, a bezel according to an embodiment of the disclosure may include a touch sensor (not shown) for detecting user interactions.

The manipulation interface 150 may be implemented as a device such as a button, a touch pad, a mouse, and a keyboard, or may be implemented as a touch screen that can perform the aforementioned display function and a manipulation input function together. A button may be various types of buttons such as a mechanical button, a touch pad, a wheel, etc. formed in any areas such as the front surface part, the side surface part, the rear surface part, etc. of the exterior of the main body of the electronic apparatus 100.

The input/output interface 160 may be any one interface among a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), or a digital visual interface (DVI). The input/output interface 160 may input or output at least one of an audio signal or a video signal. Depending on implementation examples, the input/output interface 160 may include a port inputting and outputting only audio signals and a port inputting and outputting only video signals as separate ports, or it may be implemented as one port that inputs and outputs both audio signals and video signals. The electronic apparatus 100 may transmit at least one of an audio signal or a video signal to an external apparatus (e.g., an external display apparatus or an external speaker) through the input/output interface 160. An output port included in the input/output interface 160 may be connected with an external apparatus, and the electronic apparatus 100 may transmit at least one of an audio signal or a video signal to the external apparatus through the output port.

The input/output interface 160 may be connected with the communication interface. The input/output interface 160 may transmit information received from an external apparatus to the communication interface, or transmit information received through the communication interface to an external apparatus.

The speaker 170 may be a component that outputs not only various kinds of audio data but also various kinds of notification sounds or voice messages, etc.

The microphone 180 is a component for receiving input of a user voice or other sounds and converting them into audio data. The microphone 180 may receive a voice of a user in an activated state. For example, the microphone 180 may be formed as an integrated type on the upper side or the front surface direction, the side surface direction, etc. of the electronic apparatus 100. The microphone 180 may include various components such as a microphone collecting a user voice in an analogue form, an amp circuit amplifying the collected user voice, an A/D conversion circuit that samples the amplified user voice and converts the user voice into a digital signal, a filter circuit that removes noise components from the converted digital signal, etc.

The camera 190 is a component for generating a photographed image by photographing a subject, and a photographed image is a concept including both of a moving image and a still image. The camera 190 may obtain an image for at least one external apparatus, and may be implemented as a camera, a lens, an infrared sensor, etc.

The camera 190 may include a lens and an image sensor. As types of a lens, there are general generic-purpose lenses, wide-angle lenses, zoom lenses, etc., and the type may be determined according to the type, the characteristic, the use environment, etc. of the electronic apparatus 100. As an image sensor, a complementary metal oxide semiconductor (CMOS) and a charge coupled device (CCD), etc. may be used.

According to various embodiments, the electronic apparatus 100 may include a display 140. The electronic apparatus 100 may directly display an obtained image or a content on the display 140.

According to various embodiments, the electronic apparatus 100 may not include a display 140. The electronic apparatus 100 may be connected with an external display apparatus, and transmit an image or a content stored in the electronic apparatus 100 to the external display apparatus.

The electronic apparatus 100 may transmit an image or a content to the external display apparatus together with a control signal for controlling such that the image or the content is displayed on the external display apparatus. The external display apparatus may be connected with the electronic apparatus 100 through the communication interface 130 or the input/output interface 160. For example, the electronic apparatus 100 may not include a display like a set top box (STB).

The electronic apparatus 100 may include only a small size display that can display only simple information such as text information, etc. The electronic apparatus 100 may transmit an image or a content to the external display apparatus via wire or wirelessly through the communication interface 130, or transmit them to the external display apparatus through the input/output interface 160.

There may be various embodiments wherein the electronic apparatus 100 performs an operation corresponding to a user voice signal received through the microphone 180.

According to various embodiments, the electronic apparatus 100 may control the display 140 based on a user voice signal received through the microphone 180. For example, if a user voice signal for displaying an A content is received, the electronic apparatus 100 may control the display 140 to display the A content.

According to various embodiments, the electronic apparatus 100 may control the external display apparatus connected with the electronic apparatus 100 based on a user voice signal received through the microphone 180. The electronic apparatus 100 may generate a control signal for controlling the external display apparatus such that an operation corresponding to the user voice signal is performed at the external display apparatus, and transmit the generated control signal to the external display apparatus. The electronic apparatus 100 may store a remote control application for controlling the external display apparatus. Then, the electronic apparatus 100 may transmit the generated control signal to the external display apparatus by using at least one communication method among Bluetooth, Wi-Fi, or infrared rays. For example, if a user voice signal for displaying an A content is received, the electronic apparatus 100 may transmit a control signal for controlling such that the A content is displayed on the external display apparatus to the external display apparatus. The electronic apparatus 100 may mean various terminal devices wherein a remote control application can be installed such as a smartphone, an AI speaker, etc.

According to various embodiments, the electronic apparatus 100 may use a remote control device for controlling the external display apparatus connected with the electronic apparatus 100 based on a user voice signal received through the microphone 180. The electronic apparatus 100 may transmit a control signal for controlling the external display apparatus such that an operation corresponding to the user voice signal is performed at the external display apparatus to the remote control device. Then, the remote control device may transmit the control signal received from the electronic apparatus 100 to the external display apparatus. For example, if a user voice signal for displaying an A content is received, the electronic apparatus 100 may transmit a control signal for controlling such that the A content is displayed on the external display apparatus to the remote control device, and the remote control device may transmit the received control signal to the external display apparatus.

The electronic apparatus 100 may receive a user voice signal by various methods.

According to various embodiments, the electronic apparatus 100 may receive a user voice signal through the microphone 180 included in the electronic apparatus 100.

According to various embodiments, the electronic apparatus 100 may receive a user voice signal from an external apparatus including a microphone. The external apparatus may mean a remote control device or a smartphone, etc. The received user voice signal may be a digital voice signal, but depending on implementation examples, it may be an analog voice signal. The electronic apparatus 100 may receive a user voice signal through a wireless communication method such as Bluetooth or Wi-Fi, etc.

The electronic apparatus 100 may convert a user voice signal by various methods.

According to various embodiments, the electronic apparatus 100 may obtain text information corresponding to a user voice signal from an external server. The electronic apparatus 100 may transmit a user voice signal (an audio signal or a digital signal) to the external server. The external server may mean a voice recognition server. The voice recognition server may convert the user voice signal into text information by using a Speech To Text (STT) function. Then, the external server may transmit the text information corresponding to the converted user voice signal to the electronic apparatus 100.

According to various embodiments, the electronic apparatus 100 may obtain text information corresponding to a user voice signal by itself. The electronic apparatus 100 may convert a digital voice signal into text information by directly applying a Speech To Text (STT) function, and transmit the converted text information to the external server.

The external server may transmit information to the electronic apparatus 100 by various methods.

According to various embodiments, the external server may transmit text information corresponding to a user voice signal to the electronic apparatus 100. The external server may be a server that performs a voice recognition function of converting a user voice signal into text information.

According to various embodiments, the external server may transmit at least one of text information corresponding to a user voice signal or search result information corresponding to text information to the electronic apparatus 100. The external server may be a server that performs a search result providing function of providing search result information corresponding to text information other than a voice recognition function of converting a user voice signal into text information. As an example, the external server may be a server that performs both of the voice recognition function and the search result providing function. As another example, the external server may perform only the voice recognition function, and the search result providing function may be performed at a separate server. For obtaining a search result, the external server may transmit text information to the separate server, and obtain a search result corresponding to the text information from the separate server.

The electronic apparatus 100 may be communicatively connected with the external apparatus and the external server by various methods.

According to various embodiments, a communication module for communication with the external apparatus and the external server may be implemented to be the same. For example, the electronic apparatus 100 may communicate with the external apparatus by using a Bluetooth module, and also communicate with the external server by using the Bluetooth module.

According to various embodiments, communication modules for communication with the external apparatus and the external server may be implemented to be different. For example, the electronic apparatus 100 may communicate with the external apparatus by using a Bluetooth module, and communicate with the external server by using an Ethernet modem or a Wi-Fi module.

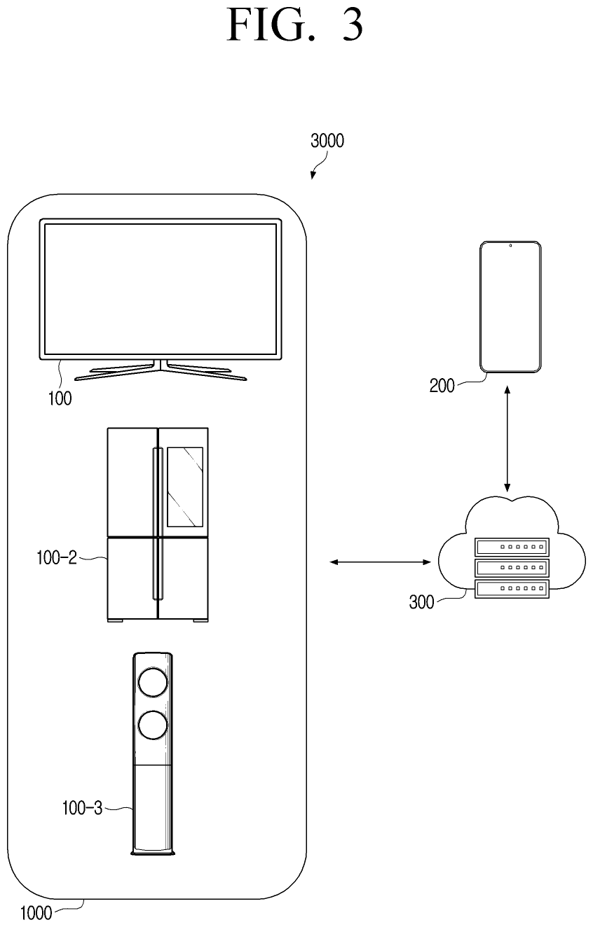

FIG. 3 is a diagram for illustrating an IoT system 3000 according to an embodiment.

The IoT system 3000 may include at least one of an IoT network 1000, a visitor terminal device 200, or a server 300.

The IoT network 1000 may include at least one IoT device 100, 100-2, 100-3. The IoT network 1000 may be connected with the server 300. The IoT devices 100, 100-2, 100-3 may be connected with the server 300. The server 300 may be connected with the IoT network 1000.

The visitor terminal device 200 may control the IoT devices 100, 100-2, 100-3 through the server 300. The visitor terminal device 200 may access (or connect to) the server 300. The visitor terminal device 200 may transmit a control command to the IoT devices 100, 100-2, 100-3 through the server 300.

The server 300 may store account information related to the visitor terminal device 200.

FIG. 4 is a diagram for illustrating an IoT system 4000 according to an embodiment.

The IoT system 4000 may include at least one of an IoT network 1000, a visitor terminal device 200, a server 300, or an AP device 500.

The IoT network 1000 may include IoT devices 100, 100-2, 100-3. The IoT network 1000 may be connected with the server 300 through the AP device 500.

The visitor terminal device 200 may perform direct communication with the electronic apparatus 100 to be connected with the AP device 500. The direct communication may include near field communication. The near field communication may include BLE communication, Wi-Fi Direct, or NFC, etc. By using the direct communication, the visitor terminal device 200 may obtain information on the AP device 500. After the AP device 500 and the visitor terminal device 200 are connected, the visitor terminal device 200 may control the IoT devices 100, 100-2, 100-3 by using the AP device 500.

The visitor terminal device 200 may be connected to the IoT network 1000 through the AP device 500. The visitor terminal device 200 may transmit a control command to the IoT devices 100, 100-2, 100-3 by using the AP device 500.

The AP device 500 may be connected to the server 300. The AP device 500 may exchange information with the server 300.

FIG. 5 is a diagram for illustrating an IoT system 5000 according to an embodiment.

The IoT system 5000 may include at least one of an IoT network 1000 or a visitor terminal device 200. The IoT network 1000 may include IoT devices 100, 100-2, 100-3.

The IoT system 5000 may not include an AP device 500. One electronic apparatus 100 among the IoT devices 100, 100-2, 100-3 may operate as an AP. The electronic apparatus 100 may generate a temporary AP. The electronic apparatus 100 may generate a temporary AP, and may be connected with the IoT devices 100-2, 100-3 through the temporary AP. The visitor terminal device 200 may perform direct communication with the electronic apparatus 100, and the visitor terminal device 200 may be connected with the IoT network 1000 through the temporary AP. The visitor terminal device 200 may transmit a control command to the IoT devices 100-2, 100-3 through the electronic apparatus 100 perform the temporary AP function.

FIG. 6 is a diagram for illustrating an IoT system 6000 according to an embodiment.

The IoT system 6000 may include at least one of an IoT network 1000 or a visitor terminal device 200. The IoT network 1000 may include IoT devices 100, 100-2, 100-3. The visitor terminal device 200 and the IoT devices 100, 100-2, 100-3 may be connected by using direct communication. The IoT devices 100, 100-2, 100-3 may be directly connected to the visitor terminal device 200 without using an AP.

FIG. 7 is a flow chart for illustrating an operation of starting sharing of IoT control.

Referring to FIG. 7, the electronic apparatus 100 may obtain a command for sharing a control right in operation S705. The command for sharing a control right may be a command that shares a control right for an IoT device included in the IoT network with a visitor. The electronic apparatus 100 may be one apparatus among the IoT devices included in the IoT network.

The electronic apparatus 100 may determine an IoT device of which control right will be shared in operation S710. The IoT device of which control right will be shared may be described as a target IoT device. The IoT network may include a plurality of IoT devices. The electronic apparatus 100 may determine at least one IoT device among the plurality of IoT devices as the target IoT device. The target IoT device may be described as a target device or a sharing device.

The electronic apparatus 100 may obtain AP information in operation S715. The electronic apparatus 100 may use an AP for connecting with an IoT device included in the IoT network. The AP may be a regular AP or a temporary AP. The regular AP may mean an AP that is used in case there is a separate AP device 500. The temporary AP may mean that one apparatus among IoT devices which are not the AP device 500 performs the AP function in itself. The electronic apparatus 100 may obtain AP information used in the IoT network to which it belongs.

The electronic apparatus 100 may generate a BLE packet for a sharing notification in operation S720. The electronic apparatus 100 may transmit a sharing notification for notifying that sharing of IoT control starts to external apparatuses. The electronic apparatus 100 may generate a communication packet including a sharing notification. The communication packet may be a BLE packet. The communication packet may be described as an advertising packet. The sharing notification may be described as an invitation notification in that it is for inviting a visitor.

The electronic apparatus 100 may broadcast the generated BLE packet in operation S725. The electronic apparatus 100 may broadcast the generated communication packet. The broadcasting operation may include an operation of transmitting a communication packet randomly to ambient apparatuses based on the electronic apparatus 100.

The visitor terminal device 200 may receive the BLE communication packet broadcasted at the electronic apparatus 100. The visitor terminal device 200 may accept sharing in response to the sharing notification (or the invitation notification) included in the BLE communication packet in operation S726. As an example, a response corresponding to a sharing notification may be automatically generated in the visitor terminal device 200. Also, as an example, a response corresponding to a sharing notification may be manually generated in the visitor terminal device 200. Further, a response may be generated in case a user directly input a response.

The visitor terminal device 200 may generate a response packet in response to the BLE communication packet. The response packet may include at least one of the contact number of the visitor terminal device 200 or the account of the visitor terminal device 200. The contact number may be described as contact information, and the account may be described as account information.

The visitor terminal device 200 may transmit a response packet including at least one of the contact number or the account to the electronic apparatus 100 in operation S727.

The electronic apparatus 100 may receive the response packet from the visitor terminal device 200. The electronic apparatus 100 may obtain at least one of the contact number of the visitor terminal device 200 or the account of the visitor terminal device 200 included in the response packet.

The electronic apparatus 100 may perform an operation of checking a contact number.

The electronic apparatus 100 may transmit a signal requesting checking of a contact number to the user terminal device 400 in operation S730. The signal requesting checking of a contact number may include a contact number and a control command for checking the contact number.

The user terminal device 400 may receive a signal requesting checking of a contact number from the electronic apparatus 100. The user terminal device 400 may obtain the contact number from the received signal. The user terminal device 400 may check the contact number (the contact number of the visitor terminal device 200) in operation S731. The user terminal device 400 may check whether the contact number is included in the contact list of the user terminal device 400. The contact number for which checking is requested may be the contact number of the visitor terminal device 200. The contact number for which checking is requested may be described as a target contact number.

For example, it is assumed that the user terminal device 400 stores 100 contact numbers of friends, family members, co-workers, etc. The user terminal device 400 may check whether the target contact number for which the electronic apparatus 100 requested checking is included in the 100 stored contact numbers.

The user terminal device 400 may obtain a checking result. The checking result may include result information regarding whether the target contact number is included in the contact list of the user terminal device 400. The user terminal device 400 may transmit the result of checking the contact number to the electronic apparatus 100 in operation S732.

The electronic apparatus 100 may receive the result of checking the contact number from the user terminal device 400. The electronic apparatus 100 may determine whether the target contact number was stored in advance in the contact list of the user terminal device 400 based on the checking result in operation S735.

In case the target contact number (the contact number of the visitor terminal device 200) was not stored in advance in the contact list (the contact list of the user terminal device 400) in operation S735-N, the electronic apparatus 100 may provide a guide UI in operation S736. The guide UI may include an operation guiding the visitor terminal device 200 that it should receive an access authority. Explanation regarding the guide UI (or screen) will be described in FIG. 23 and FIG. 24.

After providing a guide UI, the electronic apparatus 100 may check a connection authority regarding the visitor terminal device 200 in operation S737. The electronic apparatus 100 may check whether the visitor terminal device 200 obtained the connection authority through the guide UI. The connection authority may be described as an AP connection authority.

In case the connection authority of the visitor terminal device 200 is not identified in operation S737-N, the electronic apparatus 100 may provide the guide UI again.

In case the connection authority of the visitor terminal device 200 is identified in operation S737-Y, the electronic apparatus 100 may transmit AP information to the visitor terminal device 200 in operation S740.

In case the target contact number (the contact number of the visitor terminal device 200) was stored in advance in the contact list (the contact list of the user terminal device 400) in operation S735-Y, the electronic apparatus 100 may transmit the AP information to the visitor terminal device 200.

The visitor terminal device 200 may receive the AP information from the electronic apparatus 100. The visitor terminal device 200 may perform AP connection based on the received AP information in operation S741. The AP connection may mean communicative connection using the AP. The visitor terminal device 200 may access the AP (or a device function as the AP) based on the received AP information.

The electronic apparatus 100 may transmit a signal requesting checking of an account to the server 300 in operation S750. The signal requesting checking of an account may include an account and a control command for checking the account.

The server 300 may receive the signal requesting checking of an account from the electronic apparatus 100. The server 300 may obtain the account from the received signal. The server 300 may check the account (the account of the visitor terminal device 200) in operation S751. The server 300 may check whether the account is included in the account list of the server 300. The account for which checking is requested may be the account of the visitor terminal device 200. The account for which checking is requested may be described as a target account.

For example, it is assumed that the server 300 stores 1000 accounts of a plurality of users, etc. The server 300 may check whether the target account for which the electronic apparatus 100 requested checking is included in the 1000 stored accounts.

The server 300 may obtain a checking result. The checking result may include result information regarding whether the target account is included in the account list of the server 300. The server 300 may transmit the result of checking the account to the electronic apparatus 100 in operation S752.

The electronic apparatus 100 may receive the result of checking the account from the server 300. The electronic apparatus 100 may determine whether the target account (the account of the visitor terminal device 200) was stored in advance in the account list of the server 300 based on the checking result in operation S755.

In case the target account was not registered in advance in operation S755-N, the electronic apparatus 100 may generate a temporary account in operation S756. The temporary account may be an account that is temporarily generated but not a pre-registered regular account. The temporary account may be an account that is deleted in case sharing of IoT control ends. Also, the temporary account may be an account that is deleted after a predetermined period passes from the time point when sharing of IoT control ended.

After the temporary account is generated, the electronic apparatus 100 may share a control right of an IoT device with a visitor account in operation S757.

In case the target account was registered in advance in operation S755-Y, the electronic apparatus 100 may share the control right of the IoT device with the visitor account in operation S757.

The visitor account may be one of a regular account that was registered in advance or a temporary account that was temporarily generated.

The operation of sharing the control right may include an operation of sharing (or granting) a control right of an IoT device to the visitor terminal device 200. For sharing of the control right, the electronic apparatus 100 may transmit a signal indicating that the control right is granted to the visitor terminal device 200 to one of the visitor terminal device 200, the server 300, the user terminal device 400, or the AP device 500.

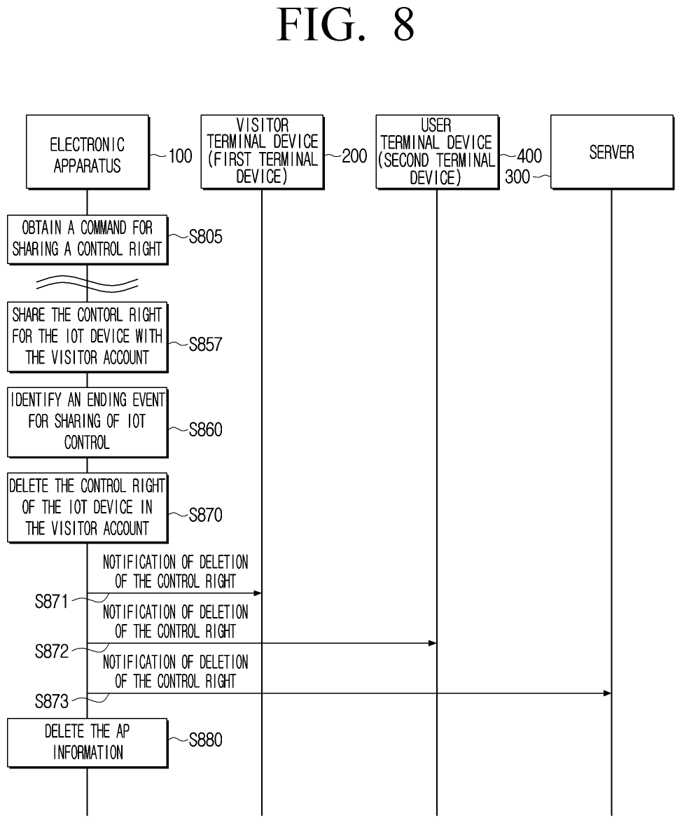

FIG. 8 is a flow chart for illustrating an operation of ending sharing of IoT control.

Referring to FIG. 8, the operations S805 to S857 may overlap with the operations S705 to S757 in FIG. 7. Accordingly, overlapping explanation will be omitted.

After sharing a control right for an IoT device with a visitor account, the electronic apparatus 100 may identify an ending event for sharing of IoT control in operation S860. The ending event for sharing of IoT control may include an event for deleting the control right. The event for deleting the control right may include at least one of an event wherein a predetermined set time has passed or an event wherein a user's ending command was received.

After the ending event was identified, the electronic apparatus 100 may delete the control right of the IoT device that was added to the visitor account in operation S870.

The electronic apparatus 100 may transmit a notification regarding deletion of the control right to the visitor terminal device 200 in operation S871. The electronic apparatus 100 may transmit the notification regarding deletion of the control right to the user terminal device 400 in operation S872. The electronic apparatus 100 may transmit the notification regarding deletion of the control right to the server 300 in operation S873. The electronic apparatus 100 may transmit the notification regarding deletion of the control right to the AP device 500.

The notification regarding deletion of the control right may include at least one of information indicating that the control right was deleted or a control command for deleting the control right that was previously shared. If the notification regarding deletion of the control right is received, each of the device that received the notification may delete the information related to sharing of the control right.

After the ending event for sharing of IoT control is identified, the electronic apparatus 100 may delete the AP information in operation S880. In case the AP information is a temporary AP, the electronic apparatus 100 may delete all information related to the temporary AP. In case the AP information is a regular AP, the electronic apparatus 100 may maintain the AP information.

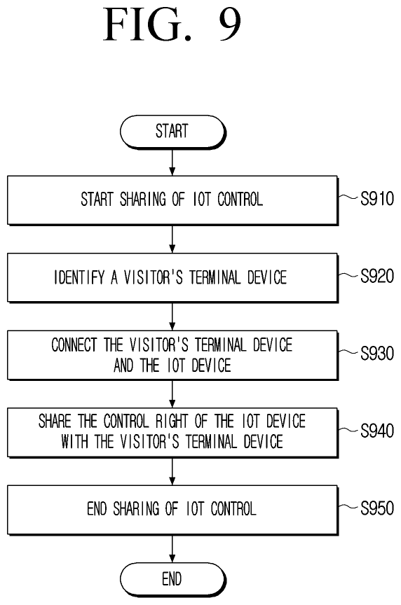

FIG. 9 is a flow chart for illustrating sharing of IoT control according to various embodiments.

Referring to FIG. 9, the electronic apparatus 100 may start sharing of IoT control in operation S910.

The electronic apparatus 100 may obtain a user input for starting sharing of IoT control from the user of the electronic apparatus 100. The sharing of IoT control may be described as an IoT sharing mode, a party mode, a meeting mode, a control right sharing mode, a smart sharing mode, etc.

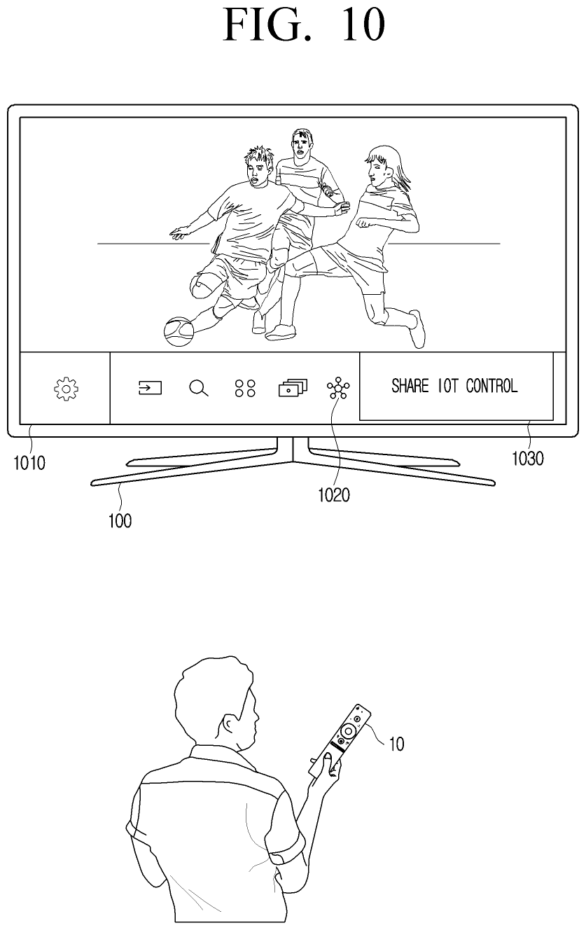

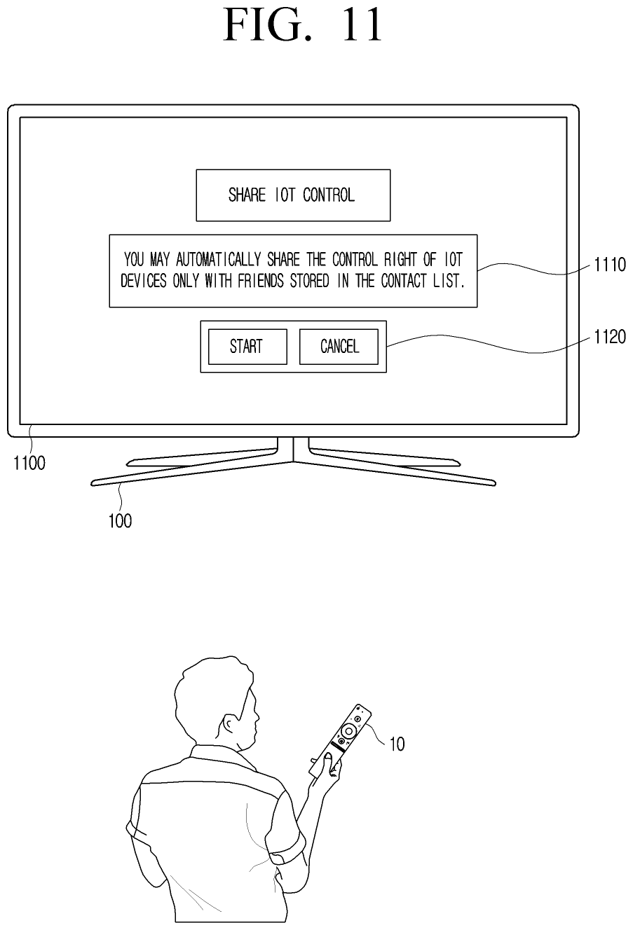

The electronic apparatus 100 may display a UI related to sharing of IoT control through the display 140 of the electronic apparatus 100. A detailed operation in this regard will be described in FIG. 10 and FIG. 11.

The electronic apparatus 100 may receive a user input through the displayed UI. The electronic apparatus 100 may receive a user voice. The electronic apparatus 100 may receive a user input through a remote control device corresponding to the electronic apparatus 100 or an integrated remote control device corresponding to the IoT network, etc. A detailed operation in this regard will be described in FIG. 10.

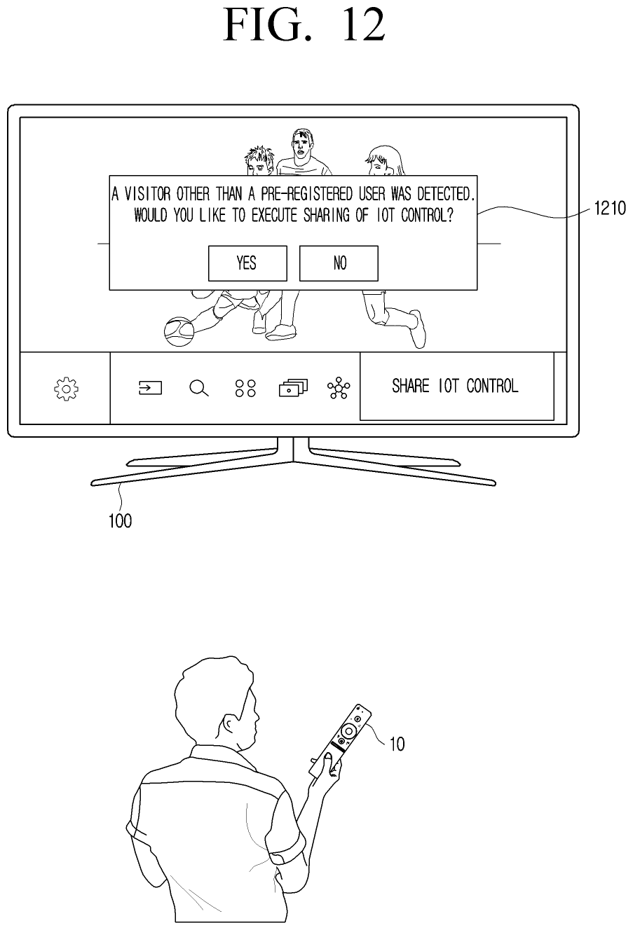

In case a user who is not a predetermined user (a visitor) is identified, the electronic apparatus 100 may identify the case as an event of starting sharing of IoT control. A detailed operation in this regard will be described in FIG. 12.

According to various embodiments, if a predetermined event occurs, the electronic apparatus 100 may start sharing of IoT control. The predetermined event may be an event wherein a predetermined application is executed. The predetermined application may be an application that was set by a user in advance for automatically starting sharing of IoT control. For example, the predetermined application may include a music reproduction application, a movie reproduction application, a chatting application, an education-related application, etc. When the predetermined application is executed through the electronic apparatus 100, the electronic apparatus 100 may automatically start sharing of IoT control.

The predetermined application may include an application related to IoT control. An application related to IoT control may include an application for control of a specific user (e.g., the user of the electronic apparatus 100).

An application related to IoT control may include a separate application for sharing a control authority with another user who is not the user of the electronic apparatus 100.

The predetermined event may include an event of receiving a signal indicating that the predetermined application was executed from the visitor terminal device 200. It is assumed that the application was installed in the visitor terminal device 200. When the application installed in the visitor terminal device 200 is executed, the visitor terminal device 200 may transmit a signal for notifying that the application was executed to the electronic apparatus 100. When the notification signal is received from the visitor terminal device 200, the electronic apparatus 100 may automatically start sharing of IoT control.

According to various embodiments, the electronic apparatus 100 may be connected with an external apparatus for controlling the electronic apparatus 100. The external apparatus may mean a user control device. For example, the electronic apparatus 100 may be controlled by the user terminal device 400. The user terminal device 400 does not necessarily have to exist around the electronic apparatus 100. The user may remotely transmit a control command for starting sharing of IoT control at the electronic apparatus to the electronic apparatus 100 through the user terminal device 400. The electronic apparatus 100 may receive the control command (a user input) through the user terminal device 400. The electronic apparatus 100 may start sharing of IT control according to the control command. The user terminal device 400 may be described as a host device, a remote host device, an IoT control device, etc.

A user input does not mean that the user input is necessarily input through the user terminal device 400, and it may be input through the visitor terminal device 200. In case a user input is input through the visitor terminal device 200, it may be described as a visitor input.

According to various embodiments, the electronic apparatus 100 may provide a chatting service. The chatting service may be a service provided through a chatting application. Also, the chatting service may be a service by which a plurality of users can have a conversation regarding one content. The chatting service may be provided through a device including a display among IoT devices. What generates and provides the chatting service may be the server 300. The server 300 may obtain and manage identification information for at least one user for providing the chatting service.

The electronic apparatus 100 may obtain a user list indicating a plurality of users who participate in the chatting service. The electronic apparatus 100 may select at least some of the plurality of users included in the user list. The electronic apparatus 100 may share a control right for the selected some users. The electronic apparatus 100 may provide (or display) a guide screen including the user list. The electronic apparatus 100 may receive a user input selecting a user to share the control right through the guide screen. The electronic apparatus 100 may obtain identification information of the terminal device corresponding to the selected user. The electronic apparatus 100 may transmit a signal related to sharing of the control right to the terminal device corresponding to the user input by using the identification information.

The chatting service may provide a menu related to sharing of a control right. If a control right sharing function is selected through the menu provided by the chatting service, the electronic apparatus 100 may provide a screen or a UI for selecting a counterpart to share the control right. The electronic apparatus 100 may receive a user input for selecting at least one counterpart through the screen or the UI. If the at least one counterpart is selected, the electronic apparatus 100 may provide a notification related to sharing of the control right to the at least one counterpart. After providing the notification, the electronic apparatus 100 may receive a signal indicating approval (or acceptance) related to sharing of the control right from the at least one counterpart. The electronic apparatus 100 may share the control right only with the terminal device that transmitted the signal indicating approval.

The electronic apparatus 100 may include a display 140. The electronic apparatus 100 may provide a screen related to the chatting service. The electronic apparatus 100 may obtain identification information related to at least one user using the chatting service. The electronic apparatus 100 may start sharing of IoT control for the obtained users of the chatting service. The electronic apparatus 100 may obtain identification information for the users of the chatting service through the server 300. The electronic apparatus 100 may grant a control right for the IoT devices based on the identification information received from the server 300. The electronic apparatus 100 may grant the control right to the accounts (or devices) corresponding to the identification information.

The electronic apparatus 100 may determine a specific IoT device of which control right was shared. The specific IoT device may be described as a target IoT device.

The electronic apparatus 100 may determine an IoT device of which control right will be granted through sharing of IoT control. The IoT device of which control right will be granted through sharing of IoT control may be described as a target IoT device. The target IoT device may be automatically determined.

The target IoT device may include the entire devices connected to the IoT network. The target IoT device may be a device connected to the electronic apparatus 100, the server 300, the AP device 500, etc.

According to various embodiments, the electronic apparatus 100 may determine an IoT device connected to the server 300 as the target IoT device. The IoT network may be connected to the server 300. The server 300 may register an IoT device included in the IoT network by using the account information of the server. The server 300 may map specific account information (the user's account information) and an IoT device. The server 300 may determine the IoT device mapped to the specific account information (the user's account information) as the target IoT device.

According to various embodiments, the electronic apparatus 100 may determine an IoT device connected to the AP device 500 as the target IoT device. The AP device 500 may store information related to an IoT device (e.g., identification information) included in the IoT network. The AP device 500 may store information regarding a connectable IoT device. The electronic apparatus 100 may request the information on the IoT device stored in the AP device 500. The AP device 500 may transmit the information on the connectable IoT device to the electronic apparatus 100 in response to the request. The electronic apparatus 100 may determine the target IoT device based on the information received from the AP device 500.

According to various embodiments, the electronic apparatus 100 may determine an IoT device connected to the electronic apparatus 100 as the target IoT device. The electronic apparatus 100 may store information related to an IoT device (e.g., identification information) included in the IoT network. The electronic apparatus 100 may store information regarding a connectable IoT device. The electronic apparatus 100 may determine the target IoT device based on the pre-stored information on the connectable IoT device.

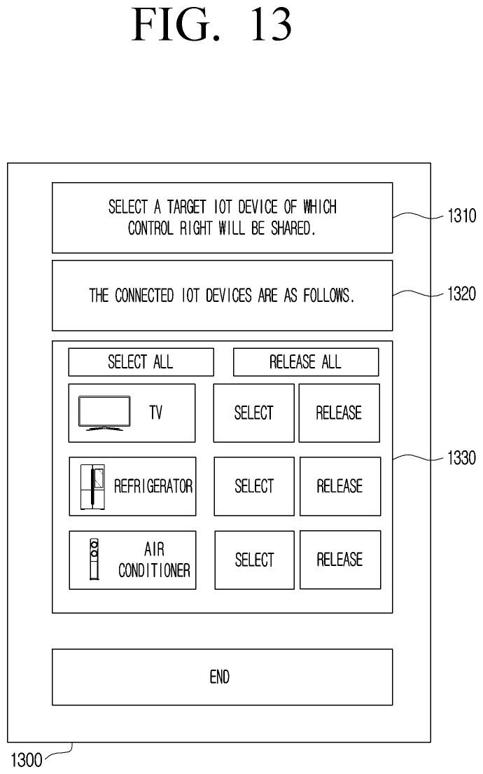

According to various embodiments, the user of the electronic apparatus 100 may directly determine a target IoT device. Explanation in this regard will be described in FIG. 13.

According to various embodiments, the electronic apparatus 100 may manage visitors to whom an invitation notification will be transmitted or target IoT devices by classifying them in groups. Explanation in this regard will be described in FIG. 14 and FIG. 15.

According to various embodiments, the electronic apparatus 100 may share a control right for each function related to an IoT device. Explanation in this regard will be described in FIG. 16.

According to various embodiments, the electronic apparatus 100 may use an AP corresponding to the IoT network.

It is assumed that the AP device 500 is connected to the IoT network. An IoT device included in the IoT network may receive a control command through the AP device 500. Also, the IoT device may transmit state information (or control information or response information) related to the IoT device to another device through the AP device 500.

The AP device 500 may be a device that was connected to the IoT network in advance. For example, the AP device 500 may be a router using Wi-Fi. The electronic apparatus 100 may obtain AP information related to the AP device 500. The electronic apparatus 100 may grant a control right by using the AP information. The electronic apparatus 100 may transmit the AP information to the visitor terminal device 200 to which the control right will be granted.

According to various embodiments, even if the AP device 500 is connected to the IoT network, the electronic apparatus 100 may operate as a temporary AP. Operating as the temporary AP may mean an operation wherein the electronic apparatus 100 directly performs the AP function. The electronic apparatus 100 may operate as the temporary AP for performing the identical/similar function to the AP device 500.

According to various embodiments, the AP device 500 may not be connected to the IoT network. In case the AP device 500 was not connected or the AP device 500 does not exist, the electronic apparatus 100 may operate as the temporary AP. The electronic apparatus 100 may generate AP information related to the temporary AP. An operation related to the temporary AP will be described in FIG. 5.

The AP information used in case the AP device 500 exists may be described as regular AP information or the first AP information.

The AP information used in case the AP device 500 does not exist may be described as temporary AP information or the second AP information.

The AP information may include at least one of the regular AP information or the temporary AP information.

According to various embodiments, the IoT network may control (or manage) an IoT device by using an individual communication method between devices. The IoT devices may use an individual direct communication method without using the AP device 500 or the temporary AP, etc. For example, an IoT device may establish a two-way communication session through BLE, Wi-Fi Direct, etc. An IoT device may be communicatively connected with the visitor terminal device 200 by using BLE, Wi-Fi Direct, etc. An operation regarding an individual communication method will be described in FIG. 6.

The electronic apparatus 100 may transmit a notification for sharing of IT control to a visitor. The electronic apparatus 100 may transmit a notification for granting a control right for an IoT device to a visitor automatically. The notification may be described as an invitation notification or an invitation message, etc. The notification may be included in a communication packet and transmitted to the visitor terminal device 200. The electronic apparatus 100 may transmit the communication packet related to the notification to the visitor terminal device 200.

As an example, the electronic apparatus 100 may transmit a communication packet (e.g., a BLE communication packet) including notification information for invitation to the visitor terminal device 200. The electronic apparatus 100 may obtain identification information (e.g., a contact number, an account, etc.) from the visitor terminal device 200 as a response to the communication packet. The electronic apparatus 100 may determine whether to grant a control right to the visitor based on the identification information. If it is determined to grant the control right, the electronic apparatus 100 may transmit the AP information to the visitor terminal device 200. An operation in this regard will be described in FIG. 7.

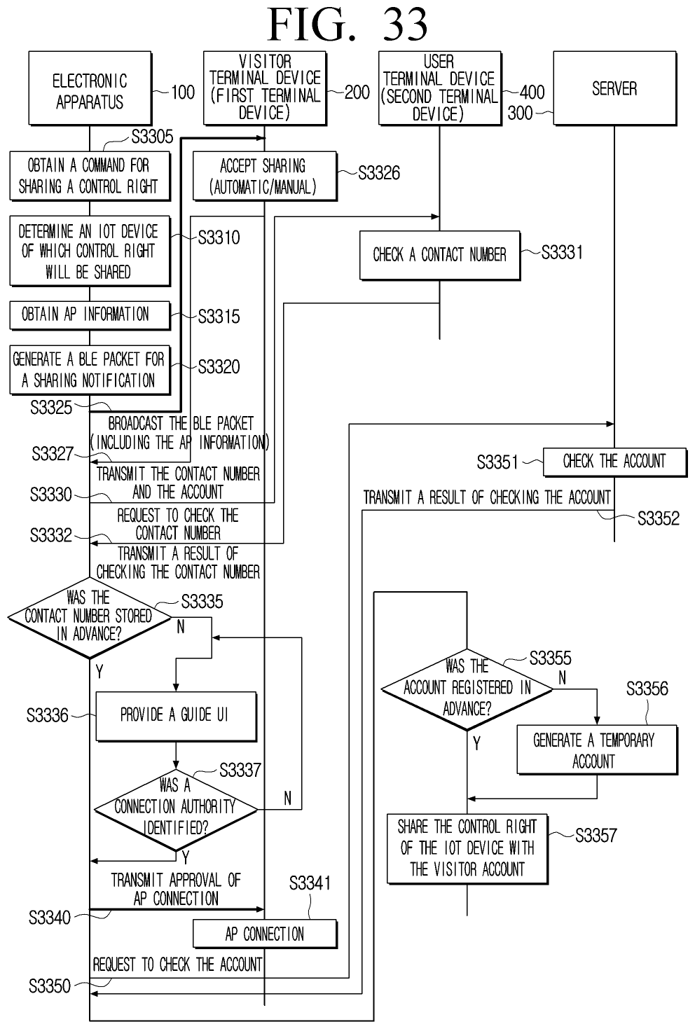

As an example, the electronic apparatus 100 may transmit a communication packet (e.g., a BLE communication packet) including the notification information for invitation and the AP information to the visitor terminal device 200. The electronic apparatus 100 may obtain identification information (e.g., a contact number, an account, etc.) from the visitor terminal device 200 as a response to the communication packet. The electronic apparatus 100 may determine whether to grant a control right to the visitor based on the identification information. If it is determined to grant the control right, the electronic apparatus 100 may transmit an approval notification for AP connection (or connection through an AP) to the visitor terminal device 200. An operation in this regard will be described in FIG. 33.

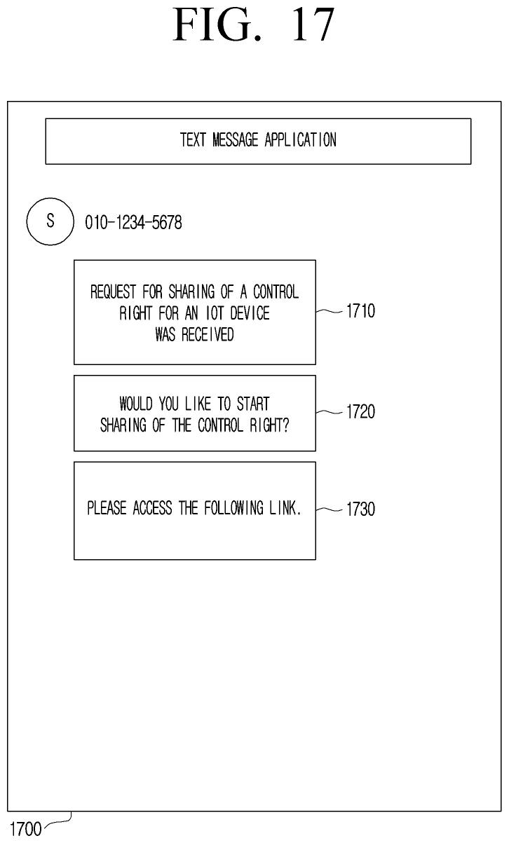

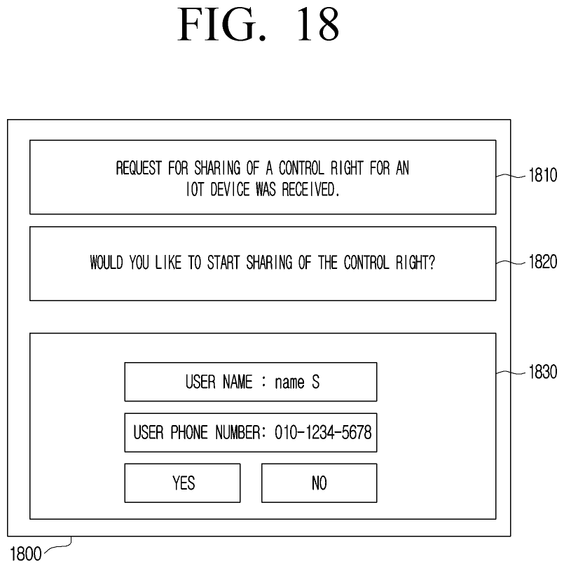

According to various embodiments, the electronic apparatus 100 may transmit an invitation notification to the visitor terminal device 200. The electronic apparatus 100 may transmit a communication packet (e.g., a BLE communication packet) including the invitation notification to the visitor terminal device 200. Explanation in this regard will be described in FIG. 17 and FIG. 18.

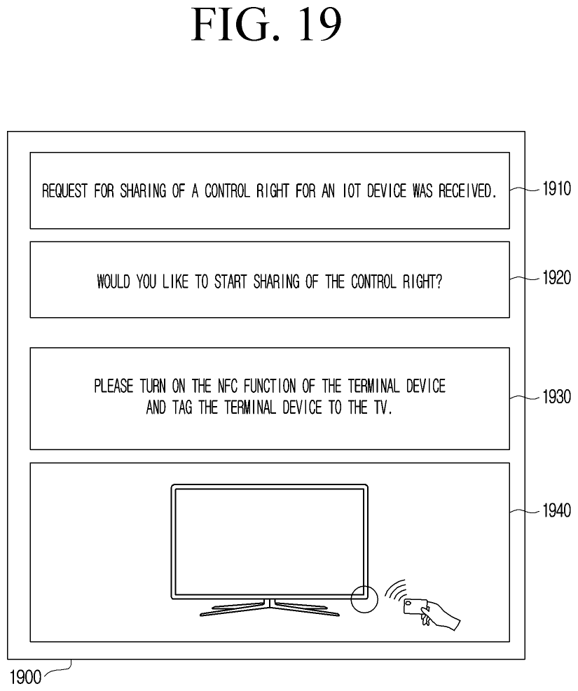

According to various embodiments, the electronic apparatus 100 may provide a guide UI for NFC tagging. Explanation in this regard will be described in FIG. 19. When NFC tagging is performed, the electronic apparatus 100 may receive contact information and/or account information from the visitor terminal device 200. According to various embodiments, when NFC tagging is performed, the electronic apparatus 100 may transmit an invitation notification to the visitor terminal device 200.

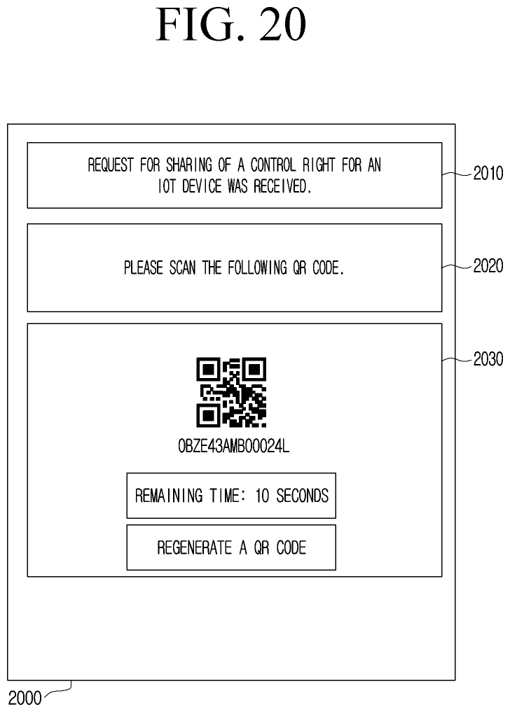

According to various embodiments, the electronic apparatus 100 may provide a guide UI for recognizing a QR code. Explanation in this regard will be described in FIG. 20.

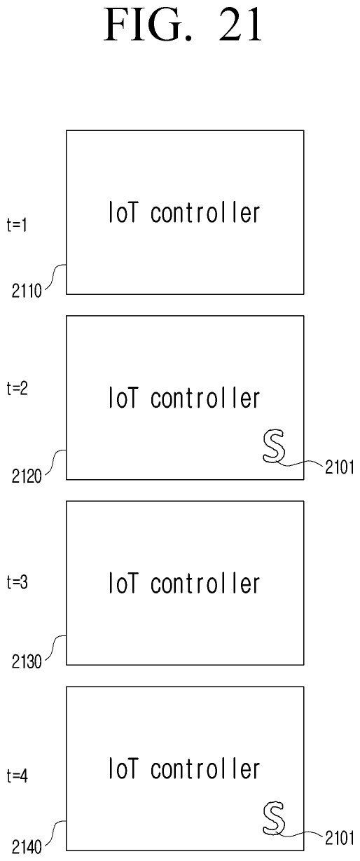

According to various embodiments, the electronic apparatus 100 may output a guide UI for recognizing a watermark. Explanation in this regard will be described in FIG. 21.

According to various embodiments, the electronic apparatus 100 may transmit an invitation notification by using an inaudible frequency. The electronic apparatus 100 may include an audio signal corresponding to a predetermined frequency. The predetermined frequency may be included in a frequency range related to an inaudible frequency. The electronic apparatus 100 may be connected with the visitor terminal device 200. The electronic apparatus 100 may request audio data to the visitor terminal device 200. The visitor terminal device 200 may transmit audio data recorded through the microphone included in the visitor terminal device 200 to the electronic apparatus 100.

The electronic apparatus 100 may analyze audio data received from the visitor terminal device 200. The electronic apparatus 100 may determine whether the predetermined frequency is identified in the audio data. If the predetermined frequency is identified in the audio data, the electronic apparatus 100 may transmit an invitation notification to the visitor terminal device 200. If the predetermined frequency is not identified in the audio data, the electronic apparatus 100 may not transmit an invitation notification to the visitor terminal device 200.

In the case of transmitting an invitation notification, the electronic apparatus 100 may transmit password information for being connected to the IoT network together. Depending on implementation examples, the electronic apparatus 100 may generate and transmit an invitation notification including the password information. The visitor terminal device 200 may receive the password information and use it in the AP connecting operation.

The electronic apparatus 100 may check the visitor terminal device 200 in operation S920.

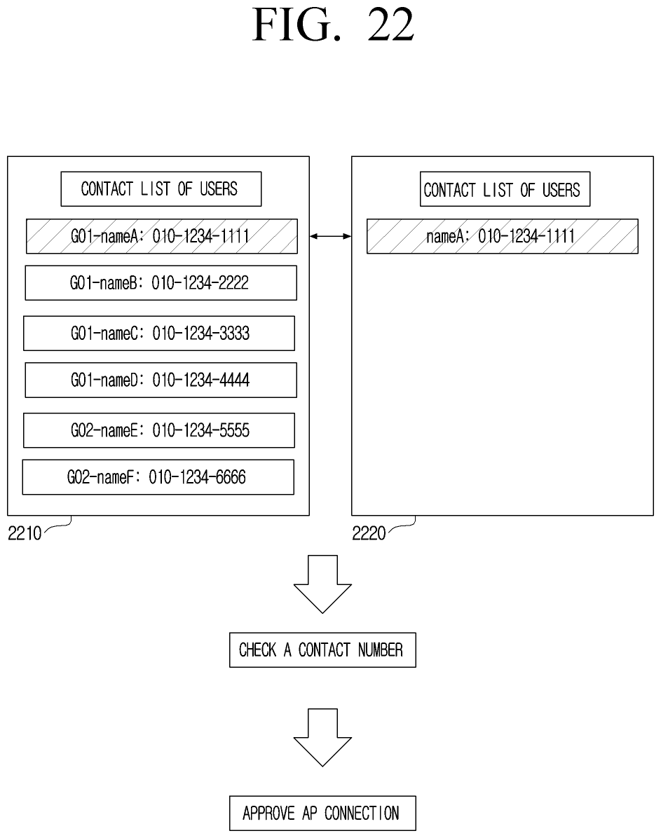

The electronic apparatus 100 may obtain identification information (a contact number, an account, etc.) from the visitor terminal device 200, and perform a checking operation. Explanation in this regard will be described in FIG. 22.

According to various embodiments, the electronic apparatus 100 may provide a chatting service. The electronic apparatus 100 may provide a chatting service corresponding to a specific content. It is assumed that the chatting service of the electronic apparatus 100 is provided to a plurality of apparatuses through the server 300. The electronic apparatus 100 may obtain identification information for users who participate in the chatting service through the server 300. The identification information may include at least one of contact numbers or accounts.

The electronic apparatus 100 may obtain a pre-stored contact list through the identification information for users obtained through the server 300. The pre-stored contact list may be a contact list for users who participate in the chatting service. The electronic apparatus 100 may compare the contact list related to the chatting service and the contact number of the visitor terminal device 200.

If the contact number of the visitor terminal device 200 is included in the contact list related to the chatting service, the electronic apparatus 100 may approve AP connection for the visitor terminal device 200.

The electronic apparatus 100 may obtain account information for a plurality of participants using the chatting service. In case it is determined that a pre-stored (or a pre-registered) account is using the chatting service, the electronic apparatus 100 may check the terminal device for the account.

According to various embodiments, before the electronic apparatus 100 completes an operation of checking (identifying) the contact number for the visitor terminal device 200, the electronic apparatus 100 may check whether the visitor terminal device 200 is connected through the AP. In case the visitor terminal device 200 directly succeeds in AP connection, the operation of checking the contact number may be unnecessary. In case the visitor terminal device 200 is already connected through the AP, the electronic apparatus 100 may determine (or regard) that checking of the contact number was performed.

The AP device may be implemented as a device that can be connected only when the password (or secret number) is input.

The AP device may be implemented as a device that can be connected even when the password is not input.

According to various embodiments, the electronic apparatus 100 may perform various operations in case the visitor terminal device 200 transmitted a response packet but failed in sharing the control right. Explanation in this regard will be described in FIG. 23.

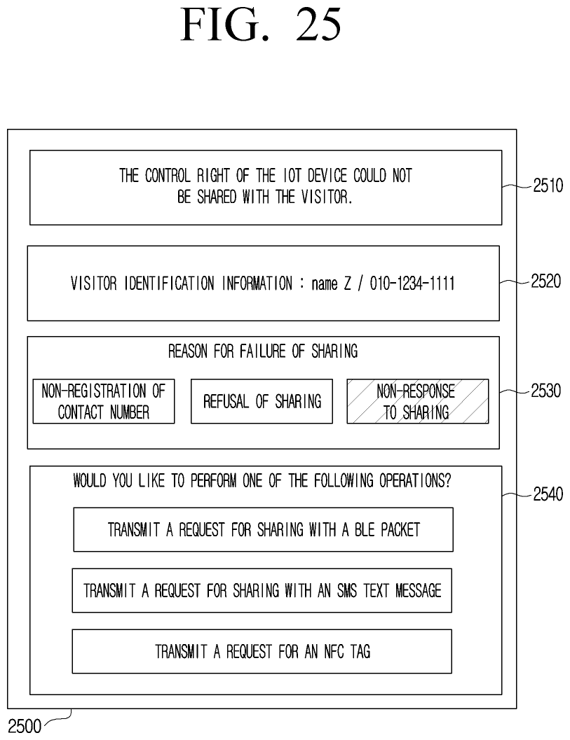

According to various embodiments, the electronic apparatus 100 may perform various operations in case the visitor terminal device 200 does not transmit a response packet. Explanation in this regard will be described in FIG. 24 and FIG. 25.

According to various embodiments, the visitor terminal device 200 may not respond to an invitation notification. The electronic apparatus 100 may wait for a response during a predetermined time from a time point when an invitation notification was transmitted.

If a response for an invitation notification was not received during the predetermined time, the electronic apparatus 100 may end sharing of IoT control.

The electronic apparatus 100 may perform control to connect the visitor terminal device 200 and an IoT device in operation S930.

The visitor terminal device 200 may be connected to an IoT device included in an IoT network by using AP information. The electronic apparatus 100 may transmit the AP information to the visitor terminal device 200. The electronic apparatus 100 may share a control right for an IoT device by using the account of the visitor terminal device 200. Explanation in this regard will be described in FIG. 26. FIG. 26 assumes a case wherein an account of a visitor or an account of the visitor terminal device 200 exists.

In case an account of a visitor is not identified, the electronic apparatus 100 may perform various operations. Explanation in this regard will be described in FIG. 27.

The electronic apparatus 100 may share a control right for an IoT device with the visitor terminal device 200 in operation S940.

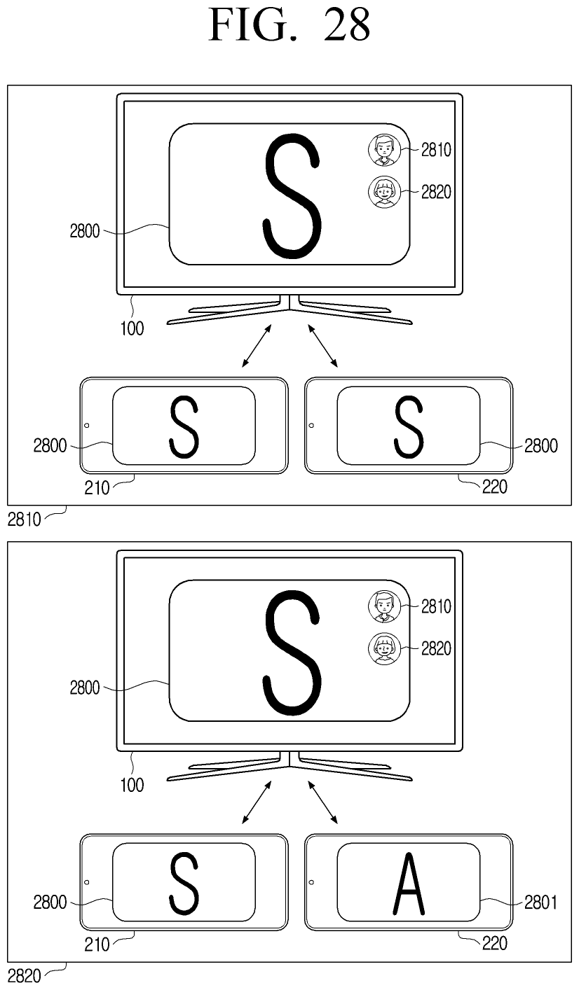

After sharing the control right, the electronic apparatus 100 may perform a screen sharing operation. Explanation in this regard will be described in FIG. 28.

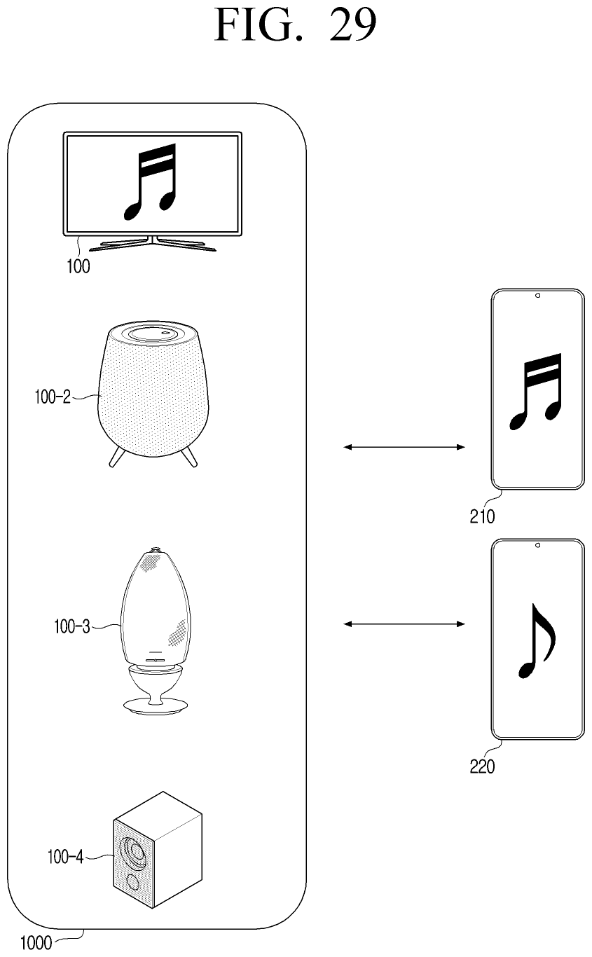

According to various embodiments, after sharing a control right, the electronic apparatus 100 may perform a music sharing operation. Explanation in this regard will be described in FIG. 29.

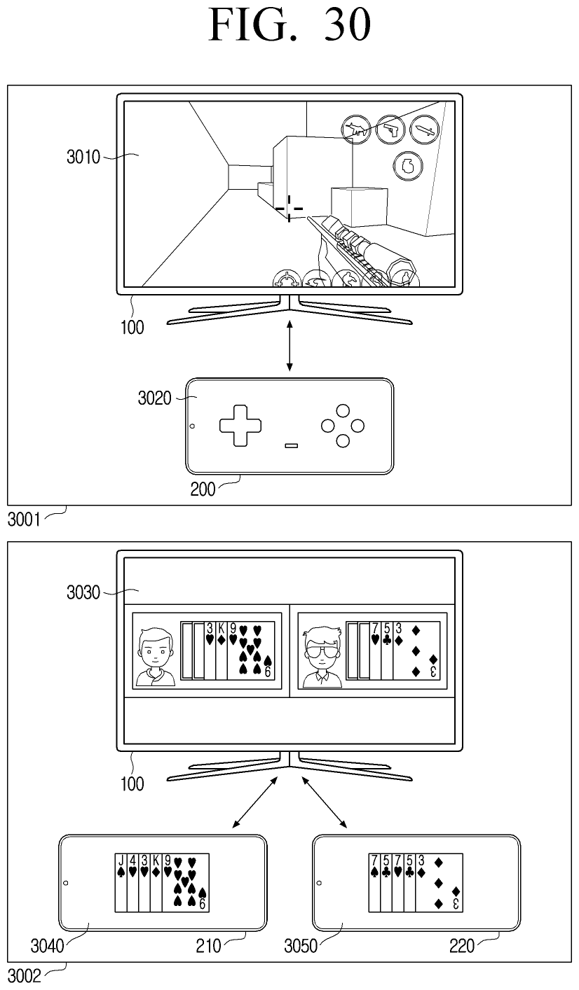

According to various embodiments, after sharing a control right, the electronic apparatus 100 may perform a game sharing operation. Explanation in this regard will be described in FIG. 30.

According to various embodiments, at least one terminal device that shares a control right may share a content with each other. For example, it is assumed that a first device 210 and a second device 220 are connected to an IoT network through an AP. The plurality of devices 210, 220 may share a specific content. Also, a specific content may be shared between the plurality of devices 210, 220 and an IoT device. An operation in this regard will be described in FIG. 28.

According to various embodiments, the electronic apparatus 100 and the plurality of devices 210, 220 may share a common content. The electronic apparatus 100 may store at least one content that was shared. When the sharing function ends, the electronic apparatus 100 may transmit the at least one stored content to some of the plurality of devices 210, 220. The electronic apparatus 100 may provide the content that was provided at the device 210 to the device 220. The electronic apparatus 100 may transmit the content that was provided at the device 220 to the device 210.

According to various embodiments, it is assumed that there are a plurality of terminal devices that share a control right. In case the plurality of terminal devices simultaneously transmit a control command, a problem that there is a collision may occur. Accordingly, there is a need to determine a host device among the plurality of terminal devices. In case the plurality of terminal devices are connected to an IoT network, one device among the plurality of terminal devices may be determined as a host device. The remaining devices may be described as guest devices.

As an example, a device determined as the host device may be a terminal device that was connected for the first time.

As an example, a device determined as the host device may be a terminal device by a user's direct selection.

The terminal device determined as the host device may share a host authority. The host authority may mean a preferential or an exclusive control authority for an IoT device. The terminal device determined as the host device may entrust the host authority to another terminal device. For example, the first device determined as the host device may entrust the host authority to the second device based on a user input.

According to various embodiments, the electronic apparatus 100 may store a user input obtained while sharing of IoT control is performed and an operation corresponding to the user input as separate histories. The histories may include at least one of a content use history (or a content viewing history) or a webpage visit history (or a webpage access history).

While sharing of IoT control is performed, the electronic apparatus 100 may divisionally store and manage a history that is collected while sharing of IoT control is performed and a history that is collected while sharing of IoT control is not performed.

The electronic apparatus 100 may store a first history that is collected while sharing of IoT control is not performed in a first group. The electronic apparatus 100 may store a second history that is collected while sharing of IoT control is performed in a second group. The electronic apparatus 100 may individually manage the first group and the second group. The electronic apparatus 100 may individually delete or update the histories included in each group.

According to various embodiments, in a state wherein sharing of IoT control was performed, the electronic apparatus 100 may display a QR code related to sharing of IoT control on the display 140. The electronic apparatus 100 may display the QR code in a predetermined area of the display 140. The electronic apparatus 100 may obtain a screen for the QR code to be displayed in the predetermined area. Explanation regarding a QR code will be described in FIG. 20.

A QR code may not be a code for a specific user. Even a user who does not share the current control right through a QR code may share the control right by using the QR code later.

According to various embodiments, in a state wherein sharing of IT control was performed, the electronic apparatus 100 may repeatedly broadcast a BLE packet for inviting a user. Even if the visitor terminal device 200 is connected to an IoT network, the electronic apparatus 100 may keep broadcasting a BLE packet for inviting an additional visitor.

The electronic apparatus 100 may end sharing of IoT control in operation S950.

The electronic apparatus 100 may provide a screen related to ending of sharing of IoT control. Explanation in this regard will be described in FIG. 31. FIG. 31 explains an event wherein a user input for ending sharing of IoT control is received.

The electronic apparatus 100 may automatically end sharing of IoT control. Explanation in this regard will be described in FIG. 32.

According to various embodiments, in case control rights for all visitors (terminal devices of visitors) were deleted (or ended), the electronic apparatus 100 may end sharing of IoT control. In case a control right for one visitor is maintained, the electronic apparatus 100 may maintain sharing of IoT control.

According to various embodiments, the electronic apparatus 100 may check an AP connection state of the visitor terminal device 200. The electronic apparatus 100 may end sharing of IoT control based on whether an AP connection with the visitor terminal device 200 was released. If AP connections of terminal devices of all visitors are released, the electronic apparatus 100 may end sharing of IoT control. An event wherein an AP connection ends may occur in a situation wherein a terminal device does not exist near a device performing an AP operation.

For example, it is assumed that the AP device 500 is arranged in a first space. In case the visitor terminal device 200 is distanced from the AP device 500 by greater than or equal to a threshold distance, the AP connection of the visitor terminal device 200 may be released.

According to various embodiments, the electronic apparatus 100 may identify whether the visitor terminal device 200 exists by using a BLE signal. The electronic apparatus 100 may broadcast a communication packet requesting a response signal by using a BLE signal. If a response signal is not received, the electronic apparatus 100 may determine that the visitor terminal device 200 does not exist in the surroundings. If response signals are not received from the terminal devices of all visitors, the electronic apparatus 100 may end sharing of IoT control.

According to various embodiments, if it is identified that a predetermined event occurred, the electronic apparatus 100 may end sharing of IoT control. The predetermined event may include at least one of an emergency situation event or a security situation event.

An emergency situation event may include at least one of an event wherein power supplied to the electronic apparatus 100 is smaller than threshold power, an event wherein power supplied to the AP device 500 is smaller than the threshold power, an event wherein all of the strengths of connection signals with an IoT device are smaller than threshold strength, an event wherein a command for forcefully ending sharing of IoT control is received from the user terminal device 400, or an event wherein a command for forcefully ending sharing of IoT control is received from the server 300.

A security situation event may include at least one of an event wherein security threat related to an IoT network is detected in real time or an event wherein it is identified that personal information is included in a screen provided by the electronic apparatus 100.

If it is identified that personal information is output through the electronic apparatus 100, the electronic apparatus 100 may perform a function of filtering personal information on the output screen. The electronic apparatus 100 may identify an area wherein personal information is displayed on a screen that will be provided, and perform blur processing on the identified area or add a predetermined block object. The electronic apparatus 100 may transmit an original screen wherein personal information was not filtered only to the host device among the plurality of terminal devices. The electronic apparatus 100 may transmit a corrected screen (a filtered screen) wherein personal information was filtered only to the guest device (a device that is not the host device) among the plurality of terminal devices.

According to various embodiments, when sharing of IoT control ends, the electronic apparatus 100 may delete account information related to visitors that was stored in the electronic apparatus 100. The visitor account information may not be deleted permanently. This is because the visitor account information may be stored in the server 300. The electronic apparatus 100 may delete the visitor account information only for the electronic apparatus 100. It may not be effective to store information of all visitors who can access the IoT network in the electronic apparatus 100.

According to various embodiments, when sharing of IoT control ends, the electronic apparatus 100 may not delete account information related to visitors, but maintain and store the information. In case a visitor is re-connected after sharing of IoT control ends, the electronic apparatus 100 may perform AP connection by using the visitor account information. The electronic apparatus 100 may directly grant a control right approval authority for a visitor of which visitor account information was already stored, or grant the approval authority first for the user by placing a priority.

According to various embodiments, when sharing of IoT control ends, the electronic apparatus 100 may delete a target IoT device that was added to the visitor account information. An operation of adding a target IoT device to the visitor account information will be described in FIG. 26. An operation contrary to the operation described in FIG. 26 may be performed. When sharing of IoT control ends, the electronic apparatus 100 may delete the target IoT device that was added to the visitor account information or a control right for the target IoT device. The electronic apparatus 100 may update the visitor account information by performing an operation of deleting the target IoT device. The visitor account information before update may include a target IoT device. The visitor account information after update may not include a target IoT device. The visitor account information may be described as the first visitor account information, the second visitor account information, the third visitor account information, etc. according to an updating operation.

According to various embodiments, when sharing of IoT control ends, the electronic apparatus 100 may not delete a target IoT device that was added to the visitor account information, but maintain and store the target IoT device. In case a visitor is re-connected after sharing of IoT control ends, the electronic apparatus 100 may perform a control right sharing operation by using the visitor account information. The electronic apparatus 100 may extract the target IoT device included in the visitor account information. The electronic apparatus 100 may directly grant a control right approval authority for the extracted target IoT device, or grant the approval authority for the IoT device by placing a priority.

FIG. 10 is a diagram for illustrating a UI for starting of sharing of IoT control.

Referring to FIG. 10, the electronic apparatus 100 may provide a UI related to setting of sharing of IoT control. When starting sharing of IoT control, the electronic apparatus 100 may provide a predetermined UI. For example, the electronic apparatus 100 may provide a UI 1010 related to sharing of IoT control. While the electronic apparatus 100 is providing a specific content, the electronic apparatus 100 may provide a UI 1010 related to sharing of IoT control according to a predetermined event.

The UI 1010 may be a UI for setting related to the electronic apparatus 100. The UI 1010 may include image data 1020 and/or text data 1030 indicating sharing of IoT control. The image data 1020 may include an icon for sharing of IoT control. The text data 1030 may include data indicating ‘sharing of IoT control’ in a language set in a TV.

According to various embodiments, the UI 1010 may be displayed on the user terminal device 400.

For performing (or starting) sharing of IoT control, the electronic apparatus 100 may receive a user input. The electronic apparatus 100 may receive a user input through various methods.

According to various embodiments, the electronic apparatus 100 may receive a user input including a user voice. The electronic apparatus 100 may receive a user voice for performing sharing of IoT control.

As an example, the electronic apparatus 100 may include a microphone 180. The electronic apparatus 100 may directly obtain a user voice through the microphone 180. The electronic apparatus 100 may perform (or start) sharing of IoT control based on a user voice received through the microphone 180.

As an example, the electronic apparatus 100 may receive signal information (or signal data) including a user voice from an external apparatus. The external apparatus may include its own microphone. The external apparatus may receive a user voice through its own microphone. The external apparatus may transmit signal information including the received user voice to the electronic apparatus 100. The electronic apparatus 100 may obtain the signal information including the user voice from the external apparatus. The electronic apparatus 100 may extract (or obtain) the user voice based on the signal information. The electronic apparatus 100 may start sharing of IoT control based on the extracted user voice.

As an example, the electronic apparatus 100 may receive signal information (or signal data) including a user voice from the visitor terminal device 200 or the user terminal device 400. Each terminal device may include a microphone. In each terminal device, an application for connection with the electronic apparatus 100 may be installed. An application may be an application having a control authority. While an application is being executed in each terminal device, each terminal device may receive a user voice through a voice recognition function provided by the application. Each terminal device may transmit signal information including a user voice to the electronic apparatus 100. The electronic apparatus 100 may receive the signal information including the user voice from each terminal device.

According to various embodiments, the electronic apparatus 100 may communicate with a remote control 10. The remote control 10 may be a device for controlling the electronic apparatus 100. The remote control 10 may be described as a device corresponding to the electronic apparatus 100. The remote control 10 may be a device for manipulating the electronic apparatus 100. The electronic apparatus 100 may receive a user input for starting sharing of IoT control through the remote control 10.

As an example, the remote control 10 may include a manipulation interface for a user manipulation. If a user input including a user manipulation is received, the remote control 10 may transmit the user input including the user manipulation to the electronic apparatus 100. The electronic apparatus 100 may extract the user manipulation based on the user input received from the remote control 10. The electronic apparatus 100 may perform an operation corresponding to the user manipulation (clicking of a specific UI, etc.). The performed operation may be an operation of starting sharing of IoT control.

As an example, the remote control 10 may include a microphone obtaining a user voice. If a user voice including a command for starting sharing of IoT control is obtained through the microphone, the remote control 10 may obtain (or generate) signal information (or signal data) including the user voice. The remote control 10 may transmit the signal information to the electronic apparatus 100. The electronic apparatus 100 may obtain the user voice based on the signal information received from the remote control 10. The electronic apparatus 100 may start sharing of IoT control based on the user voice.

In the embodiment in FIG. 10, it was described that the text data 1030 indicates sharing of IoT control. As an example, the text data 1030 may include information indicating that a member who can control an IoT device is invited.

FIG. 11 is a diagram for illustrating a notification related to sharing of IoT control.

Referring to FIG. 11, the electronic apparatus 100 may provide a screen related to sharing of IoT control. When a user input for starting sharing of IoT control is received, the electronic apparatus 100 may display a screen 1100 related to sharing of IoT control. The screen 1100 may include information related to sharing of IoT control. The screen 1100 may be described as a guide screen, a sharing mode screen, etc. The screen 1100 may include at least one of a UI 1110 including text information explaining sharing of IoT control or a UI 1120 for receiving a user command. The electronic apparatus 100 may receive a user input for starting sharing of IoT control through the UI 1120.

According to various embodiments, the screen 1100 may be displayed on the user terminal device 400.

FIG. 12 is a diagram for illustrating an operation of detecting a visitor.

Referring to FIG. 12, the electronic apparatus 100 may provide a screen related to sharing of IoT control. If it is identified that a predetermined event occurred, the electronic apparatus 100 may provide a UI 1210 related to sharing of IoT control. The predetermined event may be an event wherein a device that was not registered in an IoT network is recognized. The IoT network may be connected with at least one pre-registered IoT device. It is assumed that the electronic apparatus 100 is included in the IoT network.

The IoT network wherein the electronic apparatus 100 is included may register at least one user who can control an IoT device. Identification information may be used for identifying a user. The identification information may mean information that can specify a user and/or a device. The identification information may include at least one of account information or terminal device model information.

As an example, an IoT network may indicate a network connected to the same AP in a home.

As an example, an IoT network may indicate a network that is implemented as connection between a device and a device without an AP. The IoT network may be implemented as a mesh network.

As an example, an IoT network may indicate a network wherein at least one device existing in a home is connected to an external communication network. The IoT network may be implemented as a network that is connected to an external server through a communication chip (e.g., a USIM such as 3g, 4g, etc.) of a device existing in a home.

An IoT network may register at least one identification information. The IoT network may grant (or share) an authority to control an IoT device by using the registered identification information to a specific account (or device). The IoT network may search identification information that can connect to its network in real time.

An IoT network may identify whether searched identification information is pre-registered identification information. If the searched identification information was registered in advance, the IoT network may grant a control right to an account (or a device) corresponding to the searched identification information.

If the searched identification information was not registered in advance, the IoT network may not grant the control right to the account (or the device) corresponding to the searched identification information.

According to various embodiments, if the searched identification information was not registered in advance, the IoT network may provide a UI 1210 for notifying that identification information (or a visitor) that was not registered in advance was searched. The UI 1210 may include at least one of image data or text data indicating that identification information that was not registered in advance was searched. The image data may include a predetermined icon. The text data may include a content which is ‘a visitor other than a pre-registered user was detected.’ The UI 1210 may include a content inquiring about whether to start sharing of IoT control. The UI 1210 may include a text inquiring about whether to grant a control right to identification information (or a visitor) that was not registered in advance.

According to various embodiments, the UI 1210 may be displayed on the user terminal device 400.

FIG. 13 is a diagram for illustrating an operation of selecting a target IoT device.

Referring to FIG. 13, the electronic apparatus 100 may provide a screen 1300 related to a target IoT device. If a user input for starting sharing of IoT control or a user input for determining a target IoT device is received, the electronic apparatus 100 may provide the screen 1300. The screen 1300 may include at least one of a UI 1310 for guiding to select a device that shares a control right through sharing of IoT control, etc., a UI 1320 for explaining a list of connected IoT devices, or a UI 1330 indicating a list of connected IoT devices.

Through the UI 1330 including a list of connected IoT devices, the electronic apparatus 100 may receive a user input determining a target IoT device. The user may determine whether to grant a control right for each device through the UI 1330. The UI 1330 may include a UI for selecting all or releasing all, etc.

According to various embodiments, the screen 1300 may be displayed on the user terminal device 400.

FIG. 14 is a diagram for illustrating an operation of selecting a target IoT device for each group.

Referring to FIG. 14, the electronic apparatus 100 may provide a screen 1400 for determining an IoT device. The screen 1400 may include at least one of a UI 1410 indicating that it is a screen for determining a target IoT device, a UI 1420 for explaining a list of connected IoT devices, a UI 1430 for searching IoT devices, or a UI 1440 indicating a list of IoT devices classified in each group.

The UI 1440 indicating the list of IoT devices classified in each group may include IoT devices which are a plurality of IoT devices classified in each group according to a specific standard. For example, in the first group, a TV, an AI speaker, an air conditioner, a lighting, etc. may be included. In the second group, a computer, a CCTV, etc. may be included. The standard for classifying in each group may be the user's setting. The user may directly classify groups, and the IoT network may store such a classification result. The stored places may be the electronic apparatus 100, the server 30, the user terminal device 400, the AP device 500, etc.

According to various embodiments, the classification standard may be the security levels. A security level may be set in advance for each IoT device. There may be an IoT device that corresponds to a security level at which a control right should be granted only to a pre-registered user. Also, there may be an IoT device that corresponds to a security level at which a control right can be granted to a temporary user (a visitor). The electronic apparatus 100 may classify IoT devices in each group in advance in consideration of the security levels. The first group may be IoT devices having a relatively lower security level, and the second group may be IoT devices having a relatively higher security group.

According to various embodiments, the screen 1400 may be displayed on the user terminal device 400.

According to various embodiments, each group (the first group, the second group) may be classified as spaces in a home. For example, the first group may include devices located in the first space (e.g., the living room), and the second group may include devices located in the second space (e.g., the kitchen). The location of each group may be automatically determined. The electronic apparatus 100 may classify groups of devices by using location information of the devices included in the IoT network. The electronic apparatus 100 may provide the screen 1400 by using the groups indicating the classified groups.

According to various embodiments, each group may be manually determined by the user's setting. The user may determine in advance the groups of devices included in the IoT network. The electronic apparatus 100 may store the group information of the devices determined by the user. The electronic apparatus 100 may generate and provide the screen 1400 based on the pre-stored group information.

FIG. 15 is a diagram for illustrating an operation of selecting a visitor.

Referring to FIG. 15, the electronic apparatus 100 may provide a screen 1500 for determining a visitor who will share a control right. The screen 1500 may include at least one of a UI 1510 indicating that it is a screen for determining a visitor for sharing of the control right, a UI 1520 indicating a contact number, a UI 1530 for searching a contact number, or a UI 1540 indicating a contact list classified in each group. The contact number may include a name, a phone number, an affiliation, an address, an e-mail address, etc.

The UI 1540 indicating a contact list classified in each group may include contact numbers wherein a plurality of contact numbers were classified in each group according to a specific standard. The contact list may be classified according to a specific standard. The specific standard may be the user's arbitrary choice.

The specific standard may be classified according to affiliations. For example, affiliation information may be divided into the family, friends, companies, others, etc. If the affiliation information is the family and friends, it may be determined as the first group, and if the affiliation information is companies and others, it may be determined as the second group. The contact list may group a plurality of contact numbers according to the affiliation information. A visitor to whom a control right will be granted may be ultimately determined according to the grouped contact list. Only a contact number belonging to the first group may be determined as a visitor to whom the control right will be granted.

The electronic apparatus 100 may obtain the user's individual selection for each contact number through the UI 1540 indicating the contact list classified in each group. For example, the electronic apparatus 100 may determine whether to grant the control right to one contact number included in each group. The electronic apparatus 100 may not grant the control right to some contact numbers in the first group.

According to various embodiments, the screen 1500 may be displayed on the user terminal device 400.

FIG. 16 is a diagram for illustrating an operation of selecting a sharing mode.

Referring to FIG. 16, the electronic apparatus 100 may provide a screen 1600 related to a target function. The electronic apparatus 100 may determine a target function for which a control right will be granted among a plurality of functions provided in an IoT device. The electronic apparatus 100 may grant control rights for all of the plurality of functions. The electronic apparatus 100 may grant control rights only for some functions among the plurality of functions. The function for which the control right is ultimately granted may be described as the target function. The target function may be described as a share function.

The electronic apparatus 100 may determine a target function through the screen 1600. It is not necessary that all functions for an IoT device should be displayed. The electronic apparatus 100 may provide the screen 1600 including only predetermined functions that need to be selected as target functions. The screen 1600 may include at least one of a UI 1610 guiding to select a target function, a UI 1620 for selecting all functions at once, a UI 1630 for selecting a function corresponding to a kids mode, a UI 1640 for selecting a function corresponding to a security mode, a UI 1650 for selecting a function corresponding to an air conditioning mode, or a UI 1650 for selecting/releasing each function.

The UI 1610 guiding to select a target function may include a text which is ‘Please select a function to share.’

If a user input selecting the UI 1620 for selecting all functions at once is received, the electronic apparatus 100 may determine (or select) all functions provided on the screen 1600 as target functions.

If a user input selecting the UI 1630 for selecting a function corresponding to a kids mode is received, the electronic apparatus 100 may determine (or select) a function corresponding to the kids mode as a target function. For example, in the kids mode, the first function and the third function of the TV may be selected, and the second function of the TV may not be selected. The UI 1630 may include description information corresponding to the kids mode such as ‘A function that is inaccessible to kids under 18 is restricted.’

If a user input selecting the UI 1640 for selecting a function corresponding to a security mode is received, the electronic apparatus 100 may determine (or select) a function corresponding to the security mode as a target function. For example, in the security mode, only a function of which security level is lower than or equal to a threshold level among the plurality of functions provided in an IoT device may be determined as the target function. The UI 1640 may include description information corresponding to the security mode such as ‘Some functions that need a security authority are restricted.’

If a user input selecting the UI 1650 selecting a function corresponding to an air conditioning mode is received, the electronic apparatus 100 may determine (or select) only a function related to the air conditioning function as a target function. The UI 1650 may include description information corresponding to the air conditioning mode such as ‘Only a function related to an air conditioning operation is shared.’

Through the UI 1650 for selecting/releasing each function, the electronic apparatus 100 may receive a user input for selection/release of each individual function.

According to various embodiments, if a predetermined event is identified, the electronic apparatus 100 may output an icon related to sharing of IoT control. If the output icon is selected by a user input, the electronic apparatus 100 may provide a QR code screen related to sharing of IoT control. Detailed explanation regarding a QR code screen will be described in FIG. 20.

According to various embodiments, a screen 1600 may be displayed on the user terminal device 400.

In FIG. 16, it was described that a specific function is restricted, but depending on implementation examples, a control authority of a specific device may be restricted. Also, sharing of a control right of a specific device corresponding to a specific mode may be restricted. For example, in the kids mode, sharing of a control right of an induction device in the kitchen may be restricted.

According to various embodiments, only a control right of a specific device corresponding to a specific mode may be shared. For example, in the air conditioning mode, only a control right for an air conditioning device existing in a home may be shared. For example, in a visitor music mode, only a control right for devices that can perform a sound output function existing in a home may be shared.

FIG. 17 is a diagram for illustrating an operation of providing an invitation notification through a text message service.

Referring to FIG. 17, the electronic apparatus 100 may transmit an invitation notification to the visitor terminal device 200.

The electronic apparatus 100 may transmit a screen 1700 related to the invitation notification to the visitor terminal device 200. The visitor terminal device 200 may display a screen 1700 related to the invitation notification. The screen 1700 may include at least one of a UI 1710 notifying that a request for sharing of a control right for an IoT device was received, a UI 1720 inquiring about whether to accept sharing of the control right, or a UI 1730 guiding acceptance of the request of the control right. A screen related to an invitation notification may be described as a screen for sharing of a control right.

The UI 1710 may include a text indicating ‘A request for sharing of a control right for an IoT device was received.’

The UI 1720 may include a text indicating ‘Would you like to start sharing the control right?’

The UI 1730 may include URL information for access to a specific website such as ‘Please access the following link. https://www.share-IoT.com.’ If a user input selecting a specific URL is received through the UI 1730, the visitor terminal device 200 may transmit the user input to a device (or a server) corresponding to the URL. When the user input through the UI 1730 is obtained, the electronic apparatus 100 may grant the control right to the visitor terminal device 200.

As an example, the electronic apparatus 100 may request to the server 300 such that an invitation notification is transmitted to the visitor terminal device 200 through the server 300. The server 300 may transmit an invitation notification to the visitor terminal device 200 in response to the request.

As an example, the electronic apparatus 100 may request to the user terminal device 400 such that an invitation notification is transmitted to the visitor terminal device 200 through the user terminal device 400. The user terminal device 400 may transmit an invitation notification to the visitor terminal device 200 in response to the request.

As an example, the electronic apparatus 100 may directly transmit an invitation notification to the visitor terminal device 200.

An invitation notification may be provided to the visitor terminal device 200 through a text message function.

According to various embodiments, the URL information may include a URL for accessing a website for providing a service related to sharing of a control right. When a specific URL is accessed through the UI 1730, the visitor terminal device 200 may access a website related to sharing of a control right. The visitor terminal device 200 may additionally obtain information related to sharing of a control right or perform an operation related to sharing of a control right after accessing the website.

According to various embodiments, the URL information may include a URL generated in a state wherein a subject that will share a control right, a subject device, a subject function, an authority related to the subject function, etc. have been determined. When a specific URL is accessed through the UI 1730, the visitor terminal device 200 may immediately access a webpage for accepting sharing of a control right. The URL may indicate that a subject that will share a control right, a subject device, a subject function, an authority related to the subject function, etc. have been determined such as https://www.share-IoT.com/user2/galaxyS23/TV.

FIG. 18 is a diagram for illustrating an operation of providing an invitation notification.

Referring to FIG. 18, the visitor terminal device 200 may display a screen 1800 related to an invitation notification. The screen 1800 related to an invitation notification may include at least one of a UI 1810 notifying that a request for sharing of a control right for an IoT device was received, a UI 1820 inquiring about whether to accept sharing of the control right, or a UI 1830 guiding a response regarding sharing of the control right. The UI 1810 and the UI 1820 may correspond to the UI 1710, the UI 1720, etc. in FIG. 17. Accordingly, overlapping explanation will be omitted.

The UI 1830 may include at least one of information on a user who transmitted an invitation notification related to sharing of a control right or a UI for a response. The user information may include at least one of the name of the user, the contact number (the phone number) of the user, or the user's account. A visitor can easily recognize who transmitted the invitation notification through the user information.

FIG. 19 is a diagram for illustrating an operation of accepting an invitation notification through an NFC function.

Referring to FIG. 19, the visitor terminal device 200 may display a screen 1900 related to an invitation notification. The screen 1900 related to an invitation notification may include at least one of a UI 1910 notifying that a request for sharing of a control right for an IoT device was received, a UI 1920 inquiring about whether to accept sharing of the control right, a UI 1930 guiding a response for the request of the control right, or a UI 1940 indicating a response method. The UI 1910 and the UI 1920 may correspond to the UI 1710, the UI 1720, etc. in FIG. 17. Accordingly, overlapping explanation will be omitted.

The electronic apparatus 100 and the visitor terminal device 200 may be connected through a near field communication method. The near field communication method may be NFC communication. The electronic apparatus 100 and the visitor terminal device 200 may exchange communication through the NFC method. The visitor terminal device 200 may transmit a response regarding an invitation notification through the NFC function. The transmitted response may include identification information of the visitor terminal device 200. The identification information may be transmitted to the electronic apparatus 100 through NFC. The electronic apparatus 100 may determine whether to grant a control right to the visitor terminal device 200 by using the received identification information. The electronic apparatus 100 may provide a guide screen for NFC tagging to the visitor terminal device 200.

The UI 1930 may be a UI including a guiding operation for accepting a request for a control right. The UI 1930 may include a text indicating ‘Please turn on the NFC function of the terminal device and tag the terminal device to the TV.’

The UI 1940 may be a UI guiding a specific operation to a visitor for NFC tagging. In the electronic apparatus 100, a communication module performing the NFC function may be arranged in a specific area of the electronic apparatus 100. The UI 1940 may include information guiding an arrangement location of the communication module for the NFC function.

As an example, when the visitor terminal device 200 is tagged to the electronic apparatus 100, the identification information of the visitor terminal device 200 may be transmitted to the electronic apparatus 100. The electronic apparatus 100 may provide the identification information of the visitor terminal device 200 as a guide screen. The user of the electronic apparatus 100 may determine whether to grant a control authority by using the identification information of the visitor terminal device 200.

As an example, if a user input for granting a control authority to the visitor terminal device 200 is received, the electronic apparatus 100 may share the control right with the visitor terminal device 200.

The electronic apparatus 100 may transmit temporary AP information or media access control (MAC) address information to the visitor terminal device 200 by using the NFC function.

The visitor terminal device 200 may transmit temporary AP information or media access control (MAC) address information to the electronic apparatus 100 by using the NFC function.

Information transmitted and received between the electronic apparatus 100 and the visitor terminal device 200 may be changed according to a situation.

The electronic apparatus 100 and the visitor terminal device 200 may determine credibility by comparing information that was shared previously and information received through the NFC function. If the information received through the NFC function is identical to the pre-stored reference information (the information that was shared), the electronic apparatus 100 may share the control right with the visitor terminal device 200.

According to various embodiments, at least one of the UI 1930 or the UI 1940 may be displayed on the electronic apparatus 100.

FIG. 20 is a diagram for illustrating an operation of accepting an invitation notification through a QR code.

Referring to FIG. 20, the electronic apparatus 100 may provide a screen 2000 for an invitation notification. The screen 2000 may include at least one of a UI 2010 for notifying sharing of IoT control, a UI 2020 indicating a guiding operation related to sharing of IoT control, or a UI 2030 indicating a QR code related to an invitation notification.

The electronic apparatus 100 may transmit an invitation notification to a visitor by providing the screen 2000. The visitor may access the IoT network by using the information included in the screen 2000.

The UI 2020 may include a text guiding to scan a QR code.

The UI 2030 may include a QR code. The visitor may photograph the QR code displayed on the screen 2000 through the camera included in the visitor terminal device 200. The visitor terminal device 200 may receive an invitation notification of the electronic apparatus 100 by using the QR code included in the photographed image.

The QR code may include at least one of information related to the invitation notification or the AP information. The AP information may include information for connection with the AP device 500 or information related to the temporary AP. The QR code may include a URL of a specific website for connecting to the IoT network. When the QR code is recognized, the visitor terminal device 200 may access the specific website. When the visitor terminal device 200 accesses the specific website, the electronic apparatus 100 may receive the invitation notification.

The UI 2030 may include the remaining time during which the QR code is displayed. When the remaining time displayed on the UI 2030 passes, the electronic apparatus 100 may not display the QR code that was already displayed anymore.

In case the visitor terminal device 200 re-accesses, the electronic apparatus 100 may regenerate a QR code and display it.

The UI 2030 may include a UI indicating regeneration of a QR code. If a user input for regenerating a QR code is received through the UI 2030, the electronic apparatus 100 may regenerate a QR code.

According to various embodiments, the UI 2010 and the UI 2020 may be displayed on the visitor terminal device 200.

FIG. 21 is a diagram for illustrating an operation of accepting an invitation notification through a watermark.

Referring to FIG. 21, the electronic apparatus 100 may provide a screen including a watermark 2101 for an invitation notification. The electronic apparatus 100 may request a photographed image to the connected visitor terminal device 200. The electronic apparatus 100 may analyze the photographed image received from the visitor terminal device 200, and determine whether to transmit an invitation notification to the visitor terminal device 200.

The visitor terminal device 200 may photograph a screen provided through the electronic apparatus 100 in real time. The visitor terminal device 200 may transmit the image photographed in real time to the electronic apparatus 100. The electronic apparatus 100 may determine whether the watermark 2101 is included in the image received from the visitor terminal device 200.

If the predetermined watermark 2101 is included in the image received from the visitor terminal device 200, the electronic apparatus 100 may transmit an invitation notification to the visitor terminal device 200.

If the predetermined watermark 2101 is not included in the image received from the visitor terminal device 200, the electronic apparatus 100 may not transmit an invitation notification to the visitor terminal device 200.

According to various embodiments, the watermark 2101 may not exist in all screens provided by the electronic apparatus 100. The electronic apparatus 100 may consecutively include a plurality of screens 2110, 2120, 2130, 2140. The electronic apparatus 100 may provide a screen wherein the watermark 2101 is inserted per specific time interval in the consecutive screens. For example, in the screens on t=1 and t=3 time points, the watermark 2101 may be included, but in the screens on t=2 and t=4 time points, the watermark 2101 may not be included.

Although the time was described as t=1, 2, 3, 4, this is merely an example, and the time may be implemented in time units of various forms. The time units may be s, ms, us, etc.

The time intervals may be time units that are difficult to be visually recognized during a general user's viewing. The time intervals may be time units that can be recognized by an image sensor (e.g., a camera).

The electronic apparatus 100 may analyze a plurality of images obtained from the visitor terminal device 200, and identify whether inclusion of the watermark 2101 is displayed by a predetermined time interval. If it is identified that inclusion of the watermark 2101 is displayed by the predetermined time interval by analyzing the plurality of images obtained from the visitor terminal device 200, the electronic apparatus 100 may transmit an invitation notification to the visitor terminal device 200.

The watermark 2101 may be included in a predetermined area among the plurality of screens provided by the electronic apparatus 100. The electronic apparatus 100 may generate (or edit) the screens 2110, 2120, 2130, 2140 such that the watermark 2101 is included in the predetermined area. The screens 2110, 2120, 2130, 2140 may include an image related to a content provided by the electronic apparatus 100 and the watermark 2101 added to the image. The electronic apparatus 100 may add the watermark 2101 to the previous content.

The electronic apparatus 100 may determine whether a predetermined watermark is included based on a predetermined area in a photographed image received from the visitor terminal device 200.

FIG. 22 is a diagram for illustrating an operation of checking a contact number.

Referring to FIG. 22, if an invitation notification is received, the visitor terminal device 200 may transmit identification information to the electronic apparatus 100. The identification information may include at least one of a contact number or an account. The visitor terminal device 200 may encrypt the identification information by using a predetermined method (or a predetermined key). The visitor terminal device 200 may transmit the encrypted identification information to the electronic apparatus 100.

The electronic apparatus 100 may obtain a contact number 2220 of the visitor terminal device 200. The electronic apparatus 100 may determine whether the contact number 2220 of the visitor terminal device 200 is a pre-stored contact number based on a pre-stored contact list 2210.

The pre-stored contact list 2210 may be stored in the electronic apparatus 100. The electronic apparatus 100 may identify whether the contact number 2220 of the visitor terminal device 200 is included in the pre-stored contact list 2210.

The pre-stored contact list 2210 may be stored in the server 300. The electronic apparatus 100 may transmit the contact number 2220 of the visitor terminal device 200 to the server 300. The server 300 may identify whether the contact number 2220 of the visitor terminal device 200 is included in the pre-stored contact list 2210. The server 300 may transmit the identification result to the electronic apparatus 100.

The pre-stored contact list 2210 may be stored in the user terminal device 400. The electronic apparatus 100 may transmit the contact number 2220 of the visitor terminal device 200 to the user terminal device 400. The user terminal device 400 may identify whether the contact number 2220 of the visitor terminal device 200 is included in the pre-stored contact list 2210. The user terminal device 400 may transmit the identification result to the electronic apparatus 100.

If the contact number 2220 of the visitor terminal device 200 is included in the pre-stored contact list 2210, the electronic apparatus 100 may approve AP connection for the visitor terminal device 200.

If the contact number 2220 of the visitor terminal device 200 is not included in the pre-stored contact list 2210, the electronic apparatus 100 may not approve AP connection for the visitor terminal device 200.

According to various embodiments, the visitor terminal device 200 may transmit only some numbers in its contact number to the electronic apparatus 100. The electronic apparatus 100 may request only information according to a predetermined method (the location, the digits, etc.) in the contact number to the visitor terminal device 200.

For example, the electronic apparatus 100 may request the visitor terminal device 200 to transmit only the numbers in the four digits in the end part among the plurality of numbers included in the contact number. The visitor terminal device 200 may transmit only the numbers in the four digits in the end part in its contact number to the electronic apparatus 100 in response to the request of the electronic apparatus 100.

The electronic apparatus 100 and the visitor terminal device 200 can improve data transmission and processing efficiency by checking some numbers but not all numbers in a contact number.

FIG. 23 is a diagram for illustrating a screen that is displayed in case checking of a contact number failed.

Referring to FIG. 23, in case the contact number of the visitor terminal device 200 is not included in the pre-stored contact list, the visitor terminal device 200 may display a screen 2300. The screen 2300 may be displayed on the visitor terminal device 200 for which identification of the contact number failed. The screen 2300 may be transmitted from the electronic apparatus 100.

The screen 2300 may include at least one of a UI 2310 for notifying that the IoT network cannot be accessed, a UI 2320 indicating a guiding operation for accessing the IoT network, or a UI 2330 guiding a user input.

The UI 2320 may include a text that an authority should be obtained for accessing the IoT network. The UI 2320 may include a text requesting an inquiry to the user.

The UI 2330 may be a UI for inputting a password for accessing the IoT network. When a user input including the password is received through the UI 2330, the visitor terminal device 200 may transmit the user input including the password to the electronic apparatus 100. The electronic apparatus 100 may check the password, and determine whether to perform AP connection for the visitor terminal device 200. If the password coincides with a predetermined password, the electronic apparatus 100 may approve AP connection for the visitor terminal device 200.

According to various embodiments, the screen 2300 may be displayed on the electronic apparatus 100 but not the visitor terminal device 200.

According to various embodiments, in case the contact number of the visitor terminal device 200 is not included in the pre-stored contact list, the electronic apparatus 100 may end sharing of IoT control.

According to various embodiments, in case the contact number of the visitor terminal device 200 is not included in the pre-stored contact list, the electronic apparatus 100 may deny AP connection for the visitor terminal device 200, and maintain a standby state. The standby state may be a state wherein the electronic apparatus 100 identifies whether another device accesses the IoT network.

FIG. 24 is a diagram for illustrating a screen that is displayed in case checking of a contact number failed.

Referring to FIG. 24, if an event related to failure of sharing of a control right is identified, the electronic apparatus 100 may provide a screen 2400.

An event related to failure of sharing of a control right may be one of an event wherein a contact number is not identified, an event wherein sharing is refused, and an event wherein no response is made for sharing. An event wherein a contact number is not identified may be an event wherein the contact number of the visitor terminal device 200 is not included in the pre-stored contact list. An event wherein sharing is refused may be an event wherein a signal indicating refusal of invitation was received from the visitor terminal device 200. An event wherein no response is made for sharing may be an event wherein a response is not received during a predetermined time from a time point when an invitation notification was transmitted.

The screen 2400 may include at least one of a UI 2410 for notifying that a control right for an IoT device could not be shared, a UI 2420 indicating information on the visitor terminal device 200, a UI 2430 indicating a reason for failure of sharing, or a UI 2440 indicating a guiding operation related to failure of sharing.

The UI 2410 may include a text indicating that a control right for an IoT device was not ultimately shared with the visitor terminal device 200.

The UI 2420 may include identification information indicating the visitor terminal device 200 that failed in sharing the control right. The UI 2420 may include at least one of a name, a contact number, or an account corresponding to the visitor terminal device 200.

The UI 2430 may include a reason for failure of sharing. The reason for failure of sharing may include at least one of non-registration of a contact number, refusal of sharing, or a non-response for sharing. In FIG. 24, it is assumed that the reason for failure of sharing belongs to non-registration of a contact number. The electronic apparatus 100 may provide the UI 2440 including a guiding operation corresponding to non-registration of a contact number.

The UI 2440 may include a text indicating a guiding operation corresponding to a reason for failure of sharing. The UI 2440 may include at least one of an operation of adding the contact number of the visitor terminal device 200, an operation of temporarily granting (or sharing) a control right to the visitor terminal device 200, an operation of directly inputting an account (or an e-mail), or an operation of generating a QR code. When a user input corresponding to each operation is received, the electronic apparatus 100 may perform a guiding operation corresponding to the user input.

According to various embodiments, the screen 2400 may be displayed on the user terminal device 400.

FIG. 25 is a diagram for illustrating a screen that is displayed in case checking of a contact number failed.

Referring to FIG. 25, if an event related to failure of sharing of a control right is identified, the electronic apparatus 100 may provide a screen 2500.

The screen 2500 may include at least one of a UI 2510 for notifying that a control right for an IoT device could not be shared, a UI 2520 indicating information on the visitor terminal device 200, a UI 2530 indicating a reason for failure of sharing, or a UI 2540 indicating a guiding operation related to failure of sharing.

The UI 2510, the UI 2520, and the UI 2530 may correspond to the UI 2410, the UI 2420, and the UI 2430 in FIG. 24. Accordingly, overlapping explanation will be omitted. Unlike in FIG. 24, in FIG. 25, it is assumed that the reason for failure of sharing is a non-response for sharing. The electronic apparatus 100 may provide the UI 2540 including a guiding operation corresponding to a non-response for sharing.

The UI 2540 may include a text indicating a guiding operation corresponding to a reason for failure of sharing. The UI 2540 may include at least one of an operation of transmitting a request for sharing to the visitor terminal device 200 through the BLE packet, an operation of transmitting a request for sharing with an SMS text message, or an operation of transmitting a request for an NFC tag. When a user input corresponding to each operation is received, the electronic apparatus 100 may perform a guiding operation corresponding to the user input. An operation related to a request for an NFC tag will be described in FIG. 19.

According to various embodiments, the electronic apparatus 100 may perform a first operation of transmitting an invitation notification to the BLE packet. If an event of failure of sharing is identified after performing the first operation, the electronic apparatus 100 may perform a second operation of re-transmitting a request for sharing with an SMS text message. If an event of failure of sharing is identified after performing the second operation, the electronic apparatus 100 may perform a third operation of transmitting a request for an NFC tag.

The order of the first operation, the second operation, and the third operation may be changed depending on implementation examples.

According to various embodiments, a screen 2500 may be displayed on the user terminal device 400.

FIG. 26 is a diagram for illustrating an operation of adding a target IoT device to visitor account information.

Referring to FIG. 26, if checking of the contact number for the visitor terminal device 200 is completed, the electronic apparatus 100 may approve AP connection for the visitor terminal device 200. The electronic apparatus 100 may share a control right for connectable IoT devices with the visitor terminal device 200.

The electronic apparatus 100 may obtain a list of connectable IoT devices 2610. The electronic apparatus 100 may share a control right for IoT devices included in the list of connectable IoT devices 2610 with the visitor terminal device 200.

The electronic apparatus 100 may add (or update) the control right for the IoT devices included in the list of connectable IoT devices 2610 to the visitor account information 2620. The visitor account information 2620 may be an account corresponding to the visitor terminal device 200. When the control right is added to the visitor account information 2620, IoT devices may be controlled through the visitor account information 2620. When the visitor terminal device 200 is connected to the AP through the visitor account information 2620, the visitor terminal device 200 may directly control the IoT devices added to the visitor account information 2620.

The list of connectable IoT devices 2610 may be stored in at least one of the electronic apparatus 100, the server 300, or the user terminal device 400.

The list of connectable IoT devices 2610 may include at least one of identification information or signal strength for each IoT device. The identification information may be information indicating each IoT device. The signal strength may indicate the strength of communicative connection of each IoT device in the IoT network. As the level of the signal strength is bigger, the connection strength may be higher. For example, the signal strength of the TV (#01) may be the fifth level, the signal strength of the refrigerator (#2) may be the fifth level, the signal strength of the air conditioner (#03) may be the third level, the signal strength of the AI speaker (#04) may be the fourth level, and the signal strength of the lighting (#5) may be the first level.

The electronic apparatus 100 may determine a target IoT device based on the signal strength. Only an IoT device of which signal strength is greater than or equal to the threshold strength among at least one IoT device included in the list of connectable IoT devices 2610 may be determined as a target IoT device. It is assumed that the threshold strength is the second level. Only when the signal strength of an IoT device is greater than or equal to the second level, the IoT device may be determined as a target IoT device. For example, in case the signal strength of the lighting (#05) is the first level, the lighting (#05) may not be included in the target IoT devices.

The electronic apparatus 100 may obtain visitor account information 2620. A visitor account may be described as information related to an account of the visitor or information corresponding to the visitor account, etc. The information related to the visitor account may be stored in the server 300. The electronic apparatus 100 may receive the information related to the visitor account through the server 300. The electronic apparatus 100 may obtain and store the visitor account information 2620 to which the target IoT device was added.

When the visitor account information 2620 is stored in the electronic apparatus 100, the electronic apparatus 100 may transmit the visitor account information 2620 to at least one of the visitor terminal device 200, the server 300, the user terminal device 400, or the AP device 500. When the visitor terminal device 200 is connected to the IoT network, the visitor terminal device 200 may control the target IoT device based on the visitor account information 2620.

FIG. 27 is a diagram for illustrating a screen that is displayed in case checking of an account failed.

Referring to FIG. 27, the electronic apparatus 100 may request the visitor terminal device 200 to transmit an account related to an IoT network.

In case account information exists, the visitor terminal device 200 may transmit the account of the visitor (or the visitor account information) to the electronic apparatus 100. The electronic apparatus 100 may perform a checking operation for the visitor's account received from the visitor terminal device 200.

In case the account information does not exist, the visitor terminal device 200 may not transmit the account of the visitor (or the visitor account information) to the electronic apparatus 100, or transmit only null data.

In case the visitor account was not registered in advance, the electronic apparatus 100 may provide a screen 2700. Also, in case the visitor account was not registered in advance, the electronic apparatus 100 may generate a temporary account.

The electronic apparatus 100 may identify whether the visitor's account received from the visitor terminal device 200 was registered in advance. In case the visitor's account was not registered in advance, the electronic apparatus 100 may generate a temporary account (or temporary account information). The electronic apparatus 100 may generate a temporary account based on the contact number of the visitor terminal device 200.

The screen 2700 may include at least one of a UI 2710 indicating that a visitor account was not registered in advance, a UI 2720 indicating that a temporary account is generated, a UI 2730 indicating a temporary account, a UI 2740 indicating explanation related to the temporary account, a UI 2750 guiding generation of a formal account, or a UI 2760 guiding search of a formal account.

The screen 2700 may be a screen that is displayed in case an account related to the visitor terminal device 200 was not registered in advance.

The UI 2710 may include a text indicating ‘The visitor's account cannot be searched.’

The UI 2720 may include a text indicating ‘A temporary account was generated.’ The UI 2730 may include the generated temporary account.

The UI 2740 may include a text indicating ‘The temporary account will be deleted automatically when sharing of IoT control ends’ or ‘Subscription to a formal account is needed.’ When sharing of IoT control ends, the electronic apparatus 100 may delete the generated temporary account.

The UI 2750 may be a guide for generating a formal account. When a user input is received through the UI 2750, the electronic apparatus 100 may provide a screen for generating a formal account.

The UI 2760 may be a guide UI for searching a formal account. When a user input is received through the UI 2760, the electronic apparatus 100 may provide a screen for searching a formal account.

According to various embodiments, the screen 2700 may be displayed on the user terminal device 400.

According to various embodiments, the electronic apparatus 100 may generate a temporary account based on the name of the device corresponding to the visitor terminal device 200. The device name may include a model number, a nickname, a temporary device number, etc. indicating the visitor terminal device 200.

FIG. 28 is a diagram for illustrating an operation of sharing an image content.

Referring to FIG. 28, the electronic apparatus 100 may include a display 140.

According to the embodiment 2810, the electronic apparatus 100 may display an image provided at the at least one terminal device 210, 220 on the display 140. The at least one terminal device 210, 220 may be a device connected to an IoT network. Also, the at least one terminal device 210, 220 may be a device connected through an AP. Further, the at least one terminal device 210, 220 may be a device that was granted a control right for the electronic apparatus 100.

One device 210 from among the at least one terminal device 210, 220 may transmit a share image 2800 to the electronic apparatus 100.

The electronic apparatus 100 may receive the share image 2800 from the one device 210 from among the at least one terminal device 210, 220. The electronic apparatus 100 may display the received share image 2800 on the display 140. The one device 210 may display the share image 2800 on the display of the one device 210. The one device 210 and the electronic apparatus 100 may display the same share image 2800. The aforementioned operation may be described as an image sharing function or a content sharing function, etc. The electronic apparatus 100 and the one device 210 may simultaneously display the shared image.

According to various embodiments, the share image 2800 displayed identically may also be displayed on the remaining device 220. The IoT network including the electronic apparatus 100 may also transmit the share image 2800 to the remaining device 220 through AP connection.

According to various embodiments, the same share image 2800 may not be displayed on the remaining device 220.

The one device 210 may be described as the first device or the first connection device, and the remaining device 220 may be described as the second device or the second connection device.

According to various embodiments, icons 2810, 2820 indicating devices connected through an AP may be displayed on the share image 2800. The icons may be image data indicating specific devices. For example, the icons may include avatars indicating specific devices. The electronic apparatus 100 may provide a screen wherein the icons 2810, 2820 indicating devices connected through an AP were added to the share image 2800.

According to various embodiments, the icons 2810, 2820 may be displayed only on the screen provided at the electronic apparatus 100, and may not be displayed on the devices 210, 220.

According to various embodiments, the icons 2810, 2820 may be displayed on all devices 100, 210, 220. For this, the electronic apparatus 100 may transmit the icons 2810, 2820 and information including the display locations of the icons to the devices 210, 220.

According to the embodiment 2820, an image 2800 displayed on one device 210 and an image 2801 displayed on the remaining device 220 may be different. In case the screens displayed on each device are different, the electronic apparatus 100 may select one device. The electronic apparatus 100 may display the image displayed on the selected device. In the embodiment 2820, it is indicated that the electronic apparatus 100 selected one device 210.

The icons described in FIG. 28 may be replaced by a graphic user interface (GUI). The GUI may include at least one of moving icons, avatars, or emoticons. The GUI may be implemented in a form of moving on the screen. For example, the GUI may include moving emoticons.

FIG. 29 is a diagram for illustrating an operation of sharing an audio content.

Referring to FIG. 29, an IoT network 1000 may include IoT devices 100, 100-2, 100-3, 100-4. It is assumed that the first device 210 and the second device 220 are connected to the IoT network 1000 through an AP. The first device 210 or the second device 220 may be a device that shared a control right for the IoT devices 100, 100-2, 100-3, 100-4. If a user input is obtained by at least one device from among the first device 210 or the second device 220, the IoT devices 100, 100-2, 100-3, 100-4 may perform a function corresponding to the user input.

At least one of the IoT devices 100, 100-2, 100-3, 100-4 may include a speaker, and output a content corresponding to a user input through the speaker. The content may include audio data. For example, the content may include music data.

If a first user input that was input through the first device 210 is obtained, the IoT devices 100, 100-2, 100-3, 100-4 may perform an operation corresponding to the first user input.

If a second user input that was input through the second device 220 is obtained, the IoT devices 100, 100-2, 100-3, 100-4 may perform an operation corresponding to the second user input.

The first user input and/or the second user input may include a command for controlling one IoT device.

The first user input may include a command for outputting a first content at the electronic apparatus 100. The electronic apparatus 100 may output the first content based on the first user input. The first device 210 may transmit the first content to the electronic apparatus 100.

The second user input may include a command for outputting a second content at the IoT device 100-2. The IoT device 100-2 may output the second content based on the second user input. The second device 220 may transmit the second content to the IoT device 100-2.

An operation that a content is transmitted may include one of an operation that a content is transmitted to each IoT device through an AP or an operation that a content is transmitted through direct connection between devices. The IoT devices 100, 100-2, 100-3, 100-4 may be devices including a speaker for outputting audio data.

FIG. 30 is a diagram for illustrating an operation of sharing a game content.

Referring to FIG. 30, the electronic apparatus 100 may include a display 140. The visitor terminal device 200 may also include its own display. The electronic apparatus 100 may provide a shared content with the visitor terminal device 200 connected through an AP.

Referring to the embodiment 3001, the electronic apparatus 100 and the visitor terminal device 200 may perform an operation related to one content. The one content may be a game. The electronic apparatus 100 may perform an operation related to the content with the visitor terminal device 200 connected through an AP. The electronic apparatus 100 may provide a screen 3010 related to the game. The visitor terminal device 200 may provide a screen 3020 related to game manipulation.

The screen 3020 related to game manipulation may include an interface for user manipulation. The screen 3020 may include a UI indicating a game pad. The screen 3020 may include at least one UI indicating a manipulation button. The visitor terminal device 200 may receive a user input through the screen 3020. The visitor terminal device 200 may determine whether a specific button was selected based on the location wherein the user input was received. The electronic apparatus 100 may provide a screen 3010 to which the received user input was applied.

For example, if a user input is received in an area indicating the first button, the visitor terminal device 200 may transmit manipulation information indicating that the first button was selected to the electronic apparatus 100. The electronic apparatus 100 may provide a screen 3010 to which a received operation corresponding to the first button was reflected.

As an example, a subject updating a game screen based on a user input may be the electronic apparatus 100. The electronic apparatus 100 may generate a game screen by itself.

As an example, a subject updating a game screen based on a user input may be an external apparatus. The external apparatus may include a game console, etc. The electronic apparatus 100 may transmit a user input (or a manipulation command) obtained from the visitor terminal device 200 to the external apparatus. The external apparatus may provide the game screen updated according to the user input to the electronic apparatus 100. The electronic apparatus 100 may receive the updated game screen through the external apparatus. The electronic apparatus 100 may display the updated game screen. The external apparatus may be implemented as the server 300 or a game server, etc.

Referring to the embodiment 3002, the game screens displayed on each of the electronic apparatus 100, the terminal device 210, and the terminal device 220 may be different. The electronic apparatus 100 may be connected with a plurality of terminal devices. The plurality of terminal devices may perform one common game. For example, a poker game is assumed.

The terminal devices 210, 220 may proceed with a common game by using the electronic apparatus 100. The electronic apparatus 100 may display a common screen 3030. The terminal device 210 may display a screen 3040 corresponding to the terminal device 210, and the terminal device 220 may display a screen 3050 corresponding to the terminal device 220. On the common screen 3030, not all of the counterpart's cards may be revealed. However, on the screen displayed on each terminal device, all of its own cards may be revealed.

FIG. 31 is a diagram for illustrating an operation of deleting a control right.

Referring to FIG. 31, the electronic apparatus 100 may provide a screen 3100 related to ending of sharing of IoT control. The screen 3100 may include at least one of a UI 3110 indicating ending of sharing of IoT control, a UI 3120 for explaining a guiding operation related to deletion of a control right, or a UI 3130 for deleting a control right for each visitor.

The UI 3110 may include a text indicating ‘Sharing of IoT control ends.’

The UI 3120 may include a text indicating ‘Please select a terminal device of which control right will be deleted.’

The UI 3130 may be a UI for deleting a control right of a visitor's terminal device that shares the control right. In case there are a plurality of terminal devices of visitors, the UI 3130 may include a UI for deleting a control right of each of the plurality of terminal devices. The user may determine whether to delete the control right for each of the terminal devices of the visitors through the UI 3130. When sharing of IoT control ends, the electronic apparatus 100 may simultaneously delete the control rights for all of the plurality of visitors.

According to various embodiments, the screen 3100 may be displayed on the user terminal device 400.

According to various embodiments, if a command for deleting a control right for target IoT devices is obtained through the UI 3130, the electronic apparatus 100 may transmit information for notifying deletion of the control right to a visitor's terminal device. The visitor's terminal device may output the received information. The visitor (or the user) may realize that the control right was deleted through the output information. The target IoT devices may include a plurality of IoT devices.

According to various embodiments, if a command for deleting a control right for one IoT device is obtained through the UI 3130, the electronic apparatus 100 may delete the control right for the IoT device. Information for notifying deletion of the control right may also be transmitted to only the one IoT device.

In a state wherein a function of sharing a control right is maintained, sharing of the control right for a specific device may end. For example, sharing of the control right may be stopped (or halted) for only one device among a plurality of devices. The electronic apparatus 100 may stop sharing of the control right only for the one device based on a user input. The control right may still be shared for the remaining devices.

FIG. 32 is a diagram for illustrating a screen related to ending of sharing of IoT control.

Referring to FIG. 32, the electronic apparatus 100 may provide a screen 3200 related to ending of sharing of IoT control. The screen 3200 may include at least one of a UI 3210 indicating the ending time of sharing of IoT control, a UI 3220 for notifying that the control right will be automatically deleted, a UI 3230 indicating the set time during which sharing of IoT control is maintained, a UI 3240 indicating the current time and/or the remaining time, a UI 3520 for requesting extension of the set time, a UI 3260 indicating a target IoT device, or a UI 3270 indicating an IoT device that cannot be controlled.

The UI 3210 may include a text indicating ‘Sharing of IoT control is maintained only during the following time.’

The UI 3220 may include a text indicating ‘The control right will be automatically deleted when the set time passes.’

The UI 3230 may include the set time of sharing of IoT control that is currently set in the electronic apparatus 100.

The UI 3240 may include at least one of the current time or the remaining time that is left until sharing of IoT control ends.

The UI 3250 may be a UI that receives a user input for requesting extension of the set time.

The UI 3260 may include target IoT devices of which control rights were shared. Through the UI 3260, the electronic apparatus 100 may receive a user input for extension of the control right or deletion (ending) of the control right for each target IoT device.

The UI 3270 may include non-target IoT devices of which control rights were not shared.

According to various embodiments, the screen 3200 may be displayed on the user terminal device 400.

FIG. 33 is a flow chart for illustrating an operation wherein AP information is included in a BLE packet.

The operations S3305, S3310, S3315, S3320, S3326, S3327, S3330, S3331, S3332, S3335, S3336, S3337, S3340, S3341, S3350, S3351, S3352, S3355, S3356, and S3357 in FIG. 33 may correspond to the operations S705, S710, S715, S720, S726, S727, S730, S731, S732, S735, S736, S737, S740, S741, S750, S751, S752, S755, S756, and S757 in FIG. 7. Accordingly, overlapping explanation will be omitted.

In the operation S725 in FIG. 7, it was described that the electronic apparatus 100 transmits a BLE communication packet to the visitor terminal device 200. Also, in the operation S740 in FIG. 7, it was described that the electronic apparatus 100 transmits AP information to the visitor terminal device 200.

In the embodiment in FIG. 33, the electronic apparatus 100 may generate a BLE communication packet including AP information. The electronic apparatus 100 may transmit the BLE communication packet including the AP information to the visitor terminal device 200 in operation S3325.

The electronic apparatus 100 may broadcast the AP information in advance together with an invitation notification. In the case of transmitting the AP information in advance, the time that will be spent for AP connection later can be reduced.

In case it is determined that the contact number of the visitor terminal device 200 was stored in advance in operation S3335-Y, the electronic apparatus 100 may transmit a signal approving AP connection to the visitor terminal device 200 in operation S3340.

When the connection authority for the visitor terminal device 200 is identified in operation S3337-Y, the electronic apparatus 100 may transmit a signal approving AP connection to the visitor terminal device 200 in operation S3340.

The visitor terminal device 200 may perform AP connection by using the AP information received in advance.

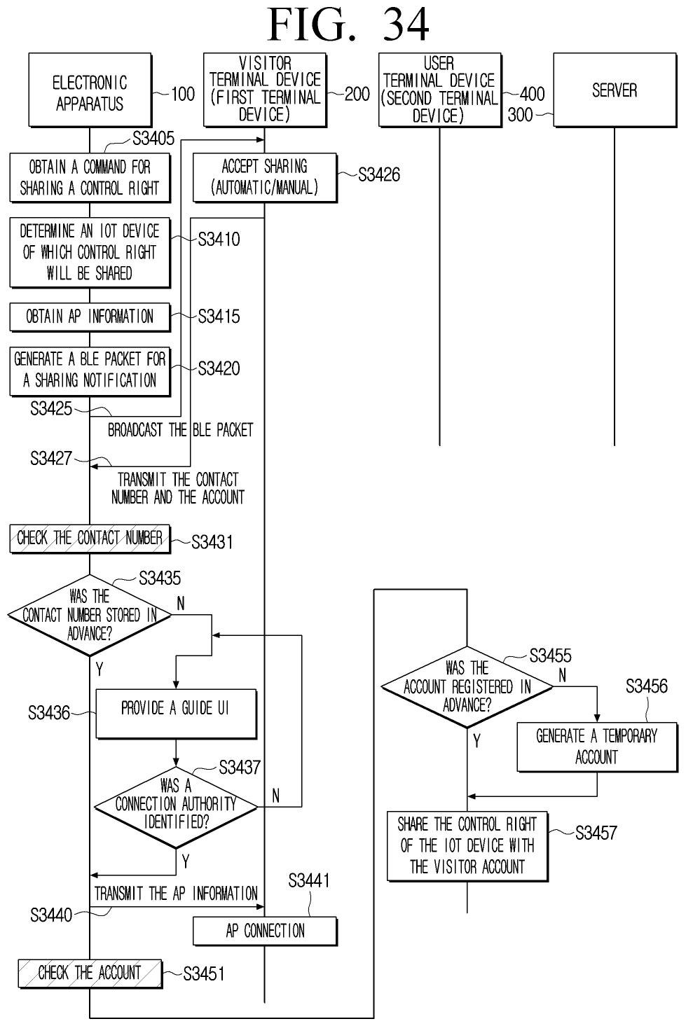

FIG. 34 is a flow chart for illustrating an operation of performing checking of a contact number and checking of an account in an electronic apparatus.

The operations S3405, S3410, S3415, S3420, S3425, S3426, S3427, S3435, S3436, S3437, S3440, S3441, S3455, S3456, and S3457 in FIG. 34 may correspond to the operations S705, S710, S715, S720, S725, S726, S727, S735, S736, S737, S740, S741, S755, S756, and S757 in FIG. 7. Accordingly, overlapping explanation will be omitted.

In the embodiment in FIG. 7, it was described that an operation of checking a contact number is performed at the user terminal device 400, and an operation of checking an account is performed at the server 300.

In the embodiment in FIG. 34, an operation of checking a contact number and an operation of checking an account may be performed at the electronic apparatus 100. The electronic apparatus 100 may store a contact list and an account list in advance.

After receiving a contact number from the visitor terminal device 200, the electronic apparatus 100 may determine whether the contact number of the visitor terminal device 200 is included in the pre-stored contact list in operation S3431.

After receiving an account from the visitor terminal device 200, the electronic apparatus 100 may determine whether the account of the visitor terminal device 200 is included in the pre-stored account list in operation S3451.

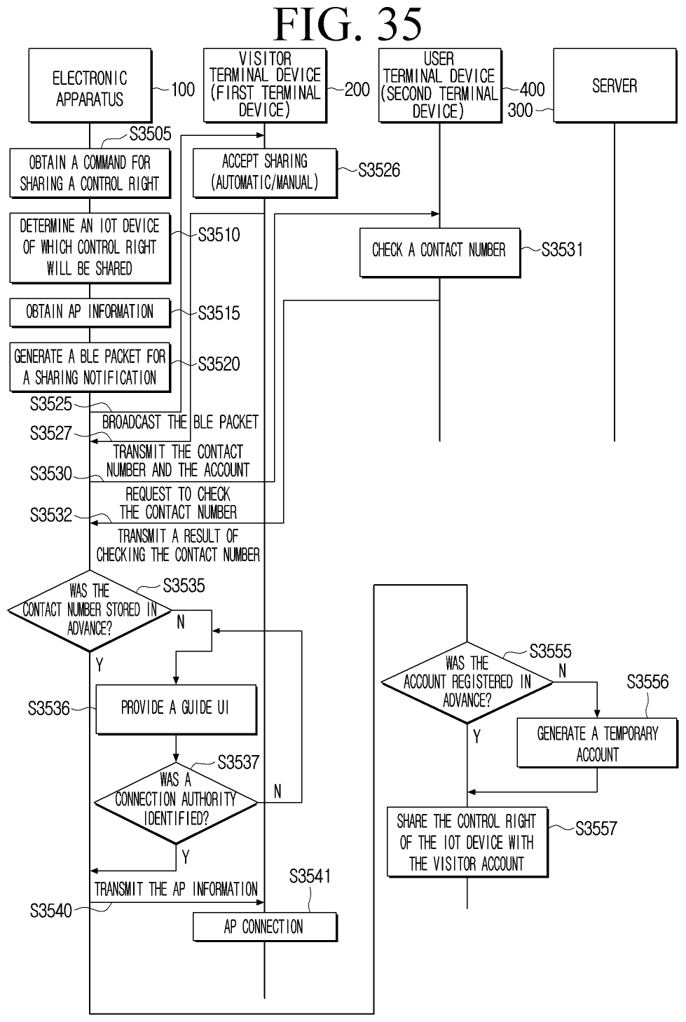

FIG. 35 is a flow chart for illustrating an operation wherein checking of a contact number is performed at the user terminal device 400 and checking of an account is performed at the electronic apparatus 100.

The operations S3505, S3510, S3515, S3520, S3525, S3526, S3527, S3530, S3531, S3532, S3535, S3536, S3537, S3540, S3541, S3555, S3556, and S3557 in FIG. 35 may correspond to the operations S705, S710, S715, S720, S725, S726, S727, S730, S731, S732, S735, S736, S737, S740, S741, S755, S756, and S757 in FIG. 7. Accordingly, overlapping explanation will be omitted.

In the embodiment in FIG. 7, an operation of checking an account was performed at the server 300. However, in the embodiment in FIG. 35, an operation of checking an account may be directly performed at the electronic apparatus 100.

The electronic apparatus 100 may store an account list in advance. The electronic apparatus 100 may request an account list to the server 300 in advance, and receive the account list from the serer 300. The electronic apparatus 100 may store the account list in advance.

After the visitor terminal device 200 is connected through an AP, the electronic apparatus 100 may identify whether the account of the visitor terminal device 200 is included in the pre-stored account list in operation S3355.

According to various embodiments, an operation of checking an account may be performed at the server 300, and an operation of checking a contact number may be performed at the electronic apparatus 100.

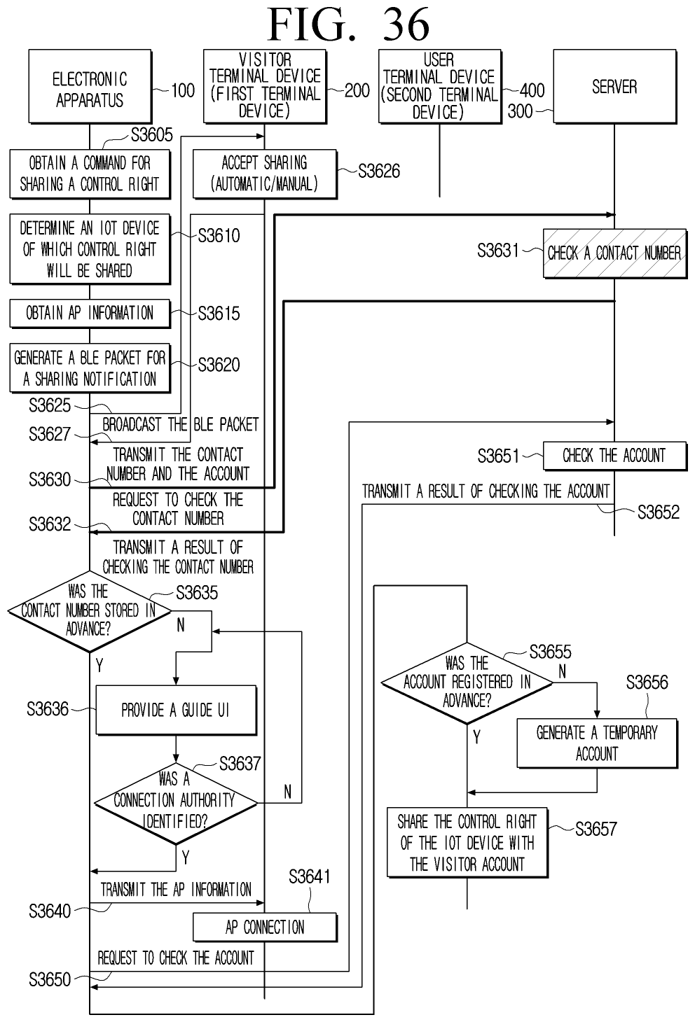

FIG. 36 is a flow chart for illustrating an operation wherein checking of a contact number and checking of an account are performed at the server 300.

The operations S3605, S3610, S3615, S3620, S3625, S3626, S3627, S3635, S3636, S3637, S3640, S3641, S3650, S3651, S3652, S3655, S3656, and S3657 in FIG. 36 may correspond to the operations S705, S710, S715, S720, S725, S726, S727, S735, S736, S737, S740, S741, S750, S751, S752, S755, S756, and S757 in FIG. 7. Accordingly, overlapping explanation will be omitted.

In FIG. 7, it was described that an operation of checking a contact number is performed at the user terminal device 400. However, in FIG. 36, an operation of checking a contact number may be performed at the server 300.

The electronic apparatus 100 may request checking of a contact number to the server 300 in operation S3630. The electronic apparatus 100 may transmit the contact number of the visitor terminal device 200 and a control command for checking the contact number to the server 300.

The server 300 may check the received contact number in operation S3631. The server 300 may perform checking of the contact number based on the pre-stored contact list. The server 300 may identify the user account of the electronic apparatus 100. The server 300 may obtain a contact list mapped to the user account of the electronic apparatus 100. The electronic apparatus 100 may obtain the contact list corresponding to the user account. The electronic apparatus 100 may determine whether the received contact number of the visitor terminal device 200 is included in the contact list of the user account.

The server 300 may obtain a result of checking the contact number. The server 300 may transmit the result of checking the contact number to the electronic apparatus 100 in operation S3632.

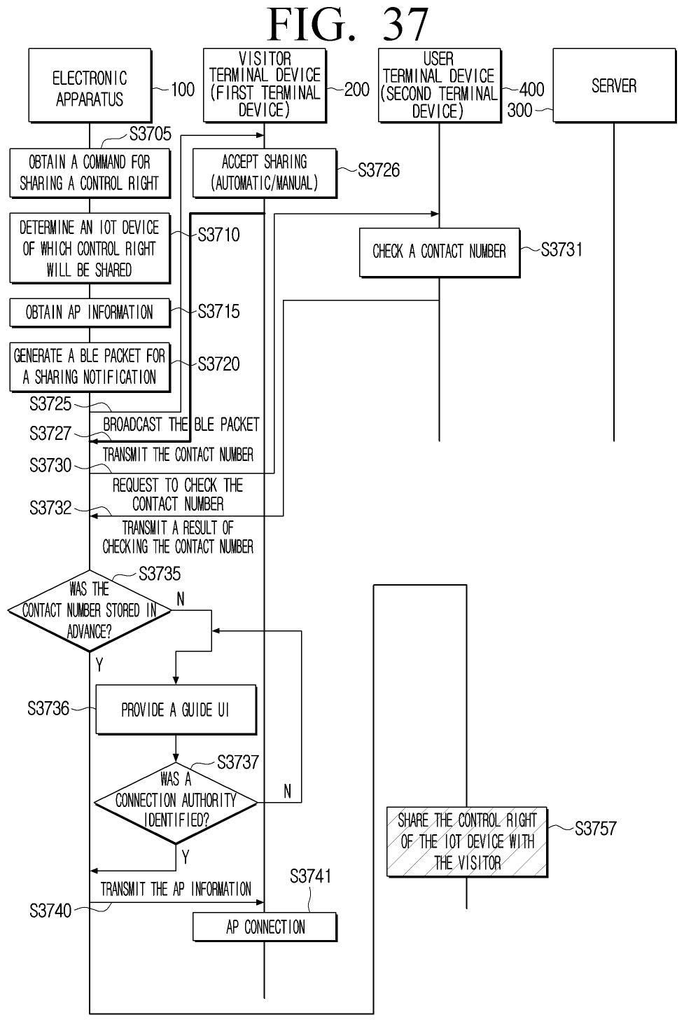

FIG. 37 is a flow chart for illustrating an operation of performing sharing of IoT control by using only a contact number.

The operations S3705, S3710, S3715, S3720, S3725, S3726, S3730, S3731, S3732, S3735, S3736, S3737, S3740, and S3741 in FIG. 37 may correspond to the operations S705, S710, S715, S720, S725, S726, S730, S731, S732, S735, S736, S737, S740, and S741 in FIG. 7. Accordingly, overlapping explanation will be omitted.

In FIG. 7, an operation of checking account information was described. However, in the embodiment in FIG. 37, a control right may directly be shared without checking account information.

The visitor terminal device 200 may transmit a contact number to the electronic apparatus 100 in response to a BLE packet in operation S3727. Unlike in the embodiment in FIG. 7, account information may not exist in the response packet.

After the visitor terminal device 200 is connected through an AP, the electronic apparatus 100 may share a control right for an IoT device with the visitor terminal device 200 in operation S3757.

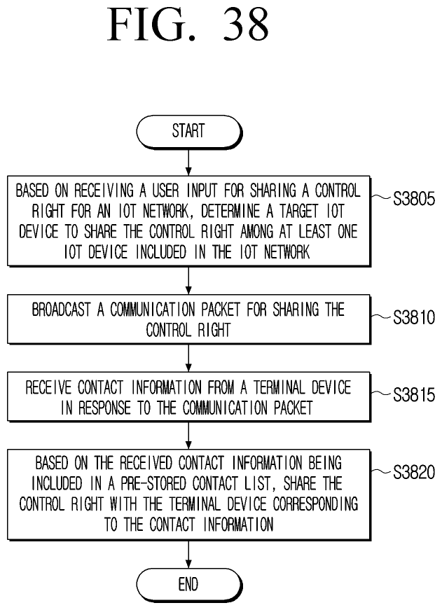

FIG. 38 is a flow chart for illustrating a controlling method of the electronic apparatus 100 according to an embodiment.

Referring to FIG. 38, a controlling method of an electronic apparatus included in an Internet of Things (IoT) network includes the operations of, based on receiving a user input for sharing a control right for an IoT network, determining a target IoT device to share the control right among at least one IoT device included in the IoT network (S3805), broadcasting a communication packet for sharing the control right (S3810), receiving contact information from a terminal device in response to the communication packet (S3815), and based on the received contact information being included in a pre-stored contact list, sharing the control right with the terminal device corresponding to the contact information (S3820).

In the operation of broadcasting the communication packet, the communication packet may be broadcasted by using Bluetooth Low Energy (BLE) communication.

The controlling method may further include the operations of, based on the received contact information being included in the pre-stored contact list, obtaining access point (AP) information corresponding to the IoT network, and transmitting the AP information to a terminal device.

The controlling method may further include the operation of, based on the received contact information not being included in the pre-stored contact list, providing a guide user interface (UI) for checking a connection authority of a terminal device.

The controlling method may further include the operations of receiving account information from a terminal device in response to a communication packet, and based on the received account information being included in the pre-stored account list, sharing the control right with a terminal device corresponding to the contact information.

The controlling method may further include the operations of, based on the received account information not being included in the pre-stored account list, generating temporary account information, and sharing the control right with the terminal device based on the temporary account information.

In the operation of generating the temporary account information, the temporary account information may be generated based on the contact information received from the terminal device.

The controlling method may further include the operation of updating the account information such that a control right for a target IoT device is added.

The controlling method may further include the operations of, based on receiving a user input for sharing the control right for the IoT network, maintaining sharing of IoT control for sharing the control right with the terminal device during a predetermined time, and based on the predetermined time passing, deleting the control right shared to the terminal device.

In the operation of determining the target IoT device, signal strength corresponding to each of the at least one IoT device included in the IoT network may be obtained, and an IoT device of which signal strength is greater than or equal to a threshold value among the at least one IoT device may be determined as the target IoT device.

Meanwhile, the methods according to the aforementioned various embodiments of the disclosure may be implemented in forms of applications that can be installed on conventional electronic apparatuses.

Also, the methods according to the aforementioned various embodiments of the disclosure may be implemented just with software upgrade, or hardware upgrade of conventional electronic apparatuses.

In addition, the methods according to the aforementioned various embodiments of the disclosure may be performed through an embedded server provided on an electronic apparatus, or an external server of at least one of an electronic apparatus or a display apparatus.

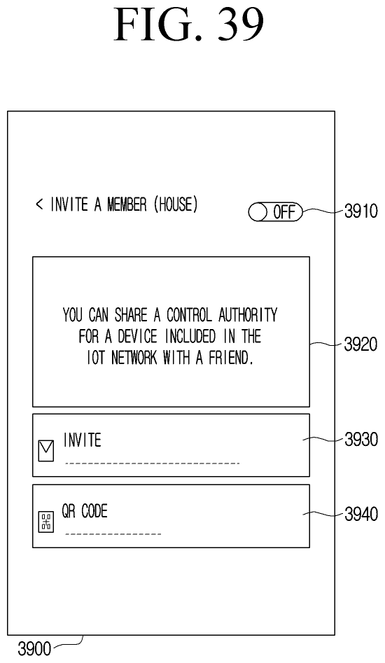

FIG. 39 is a diagram for illustrating a screen related to sharing of IoT control according to an embodiment.

The screen 3900 in FIG. 39 may include at least one of an on/off UI 3910 of sharing of IoT control, an explanation UI 3920, an invitation UI 3930, or a code UI 3940.

The on/off UI 3910 may include a UI that can turn on or turn off sharing of IoT control.

The explanation UI 3920 may include information (e.g., texts) explaining functions related to sharing of IoT control.

The invitation UI 3930 may be a UI for performing an operation of transmitting an invitation message for sharing a control authority to a device designated by the user. If a user input selecting the invitation UI 3930 is received, the electronic apparatus 100 may newly provide a screen for performing an operation for transmitting a control authority to a counterpart to be invited (e.g., a friend). The invitation method may be at least one of an e-mail, a text message, or provision of a URL.

The code UI 3940 may be a UI providing a code for granting a control authority. If a user input selecting the code UI 3940 is received, the electronic apparatus 100 may newly provide a screen indicating a code including a control authority. For example, the screen indicating a code may include at least one of an authorization number or a QR code.

Meanwhile, according to an embodiment of the disclosure, the aforementioned various embodiments of the disclosure can be implemented as software including instructions stored in a machine-readable storage medium that is readable by a machine (e.g.: a computer). The machines refer to apparatuses that call instructions stored in a storage medium, and can operate according to the called instructions, and the apparatuses may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: a compact disc read only memory (CD-ROM)), or may be distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Also, each of the components (e.g.: a module or a program) according to the aforementioned various embodiments may consist of a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a communication interface; and
at least one processor configured to:
based on occurrence of an event in which control information allowing control over a target apparatus be provided, identify the target apparatus among at least one external apparatus connected with the electronic apparatus,
broadcast a packet, in association with providing the control information, through the communication interface,
receive identification information, from an apparatus that responds to the packet, through the communication interface, and
based on the received identification information from the apparatus being included in pre-stored identification information, provide the control information allowing control over the target apparatus to the apparatus.

2. The electronic apparatus of claim 1, wherein the event is a user input requesting the control information, and
the at least one processor is configured to:
broadcast the packet by using Bluetooth Low Energy (BLE) communication through the communication interface.

3. The electronic apparatus of claim 1,
wherein the at least one processor is configured to:
based on a contact number obtained through the received identification information being included in the pre-stored identification information, transmit information of an access point (AP) through which the electronic apparatus is connected to the apparatus that responded to the packet through the communication interface.

4. The electronic apparatus of claim 1,
wherein the at least one processor is configured to:
based on a contact number obtained through the received identification information not being included in the pre-stored identification information, control a user interface (UI) to be provided to check a connection authority of the apparatus that responded to the packet.

5. The electronic apparatus of claim 1,
wherein the at least one processor is configured to:
receive account information from the apparatus that responded to the packet through the communication interface, and
based on the received account information being included in a pre-stored account list, provide the control information to the apparatus that responded to the packet based on the account information.

6. The electronic apparatus of claim 5,
wherein the at least one processor is configured to:
based on the received account information not being included in the pre-stored account list, generate temporary account information, and
provide the control information to the apparatus that responded to the packet based on the temporary account information.

7. The electronic apparatus of claim 6,
wherein the at least one processor is configured to:
generate the temporary account information based on a contact number obtained through the identification information received from the apparatus that responded to the packet.

8. The electronic apparatus of claim 5,
wherein the at least one processor is configured to:
update the account information received from the apparatus such that the control information for the target apparatus is added to the account information.

9. The electronic apparatus of claim 1,
wherein the at least one processor is configured to:
based on the event being receiving a user input to provide the control information, control to maintain a state for providing the control information to the apparatus that responded to the packet during a predetermined time, and
wherein the control information is no longer provided, based on the predetermined time passing, to the apparatus that responded to the packet.

10. The electronic apparatus of claim 1,
wherein the at least one processor is configured to:
obtain signal strength of the at least one external apparatus connected with the electronic apparatus, respectively, and
based on the signal strength, of an external apparatus among the at least one external apparatus, being greater than or equal to a threshold value, identify the external apparatus as the target apparatus.

11. A controlling method of an electronic apparatus, the controlling method comprising:
based on occurrence of an event in which control information allowing control over a target apparatus be provided, identifying the target apparatus among at least one external apparatus connected with the electronic apparatus;
broadcasting a packet in association with providing the control information;
receiving identification information from an apparatus that responds to the packet; and
based on the received identification information from the apparatus being included in pre-stored identification information, providing the control information allowing control over the target apparatus to the apparatus.

12. The controlling method of claim 11, wherein the event is a user input requesting the control information, and
the broadcasting of the packet comprises:
broadcasting the packet by using Bluetooth Low Energy (BLE) communication.

13. The controlling method of claim 11, further comprising:
based on a contact number obtained through the received identification information being included in the pre-stored identification information, transmitting information of an access point (AP) through which the electronic apparatus is connected to the apparatus that responded to the packet.

14. The controlling method of claim 11, further comprising:
based on a contact number obtained through the received identification information not being included in the pre-stored identification information, controlling a user interface (UI) to be provided to check a connection authority of the apparatus that responded to the packet.

15. The controlling method of claim 11, further comprising:
receiving account information from the apparatus that responded to the packet; and
based on the received account information being included in a pre-stored account list, providing the control information to the apparatus that responded to the packet based on the account information.
